(19) United States
(12) Patent Application Publication
(10) Pub. No.: US 2015/0368372 A1
(43) Pub. Date: Dec. 24, 2015

(54) Cellulosic Arabinoxylan fiber (CAF) And Methods Of Preparing

(71) Applicants: The United States of America, as represented by the Secretary of Agriculture, Washington, DC (US); Z-Trim Holdings Inc., Mundelein, IL (US)

(72) Inventors: Madhav P. Yadav, North Wales, PA (US); Kevin B. Hicks, Malvern, PA (US); David Johnston, Wyndmoor, PA (US); Kyle A. Hanah, Mount Prospect, IL (US); Madhuvanti S. Kale, Flourtown, PA (US)

(21) Appl. No.: 14/745,962

(22) Filed: Jun. 22, 2015

Related U.S. Application Data
(60) Provisional application No. 62/016,224, filed on Jun. 24, 2014.

(51) Int. Cl. C08B 37/00; A23L 1/03

(52) U.S. Cl. CPC C08B 37/0057; A23L 1/031; A23V 2002/00

(57) ABSTRACT

Processes for the preparation of cellulosic arabinoxylan fiber. Cellulosic arabinoxylan fiber prepared by the processes. Edible formulations, containing the cellulosic arabinoxylan fiber, wherein the cellulosic arabinoxylan fiber functions as bulking agents in the edible formulation. Methods of stabilizing an emulsion, involving mixing an effective stabilizing amount of the cellulosic arabinoxylan fiber with an emulsion to stabilize said emulsion. Methods of increasing the water holding capacity of a composition, involving mixing an effective water holding increasing amount of the cellulosic arabinoxylan fiber with a composition to increase the water holding capacity of said composition. Method of increasing the bulk of a composition, involving mixing an effective bulk increasing amount of the cellulosic arabinoxylan fiber with a composition to increase the water holding capacity of said composition. Methods of increasing the viscosity of a composition, involving mixing an effective viscosity increasing amount of the cellulosic arabinoxylan fiber with a composition to increase the viscosity of said composition.

### REFERENCE TO RELATED APPLICATION

This application claims the benefit of U.S. Provisional Application No. 62/016,224, filed 24 Jun. 2014, which is incorporated herein by reference in its entirety.

### BACKGROUND OF THE INVENTION

Processes for the preparation of cellulosic arabinoxylan fiber involving:
(a) mixing ground agricultural materials in water at temperatures in the range of about 75° C. to about 100° C. to form a suspension, adjusting the pH of said suspension from about 5.2 to about 6.8, and adding thermostable α-amylase to said suspension,
(b) adjusting the pH of the suspension to about 11.5,
(c) subjecting the suspension to shearing at about 10,000 rpm for about 1 hour and centrifuging the suspension at about 14,000×g for about 10 minutes to form a supernatant and a solid residue,
(d) mixing the solid residue with water at temperatures in the range of about 75° C. to about 100° C. to form a suspension,
(e) subjecting the suspension from (d) to shearing at about 10,000 rpm for about 5 minutes, cooling said suspension to about room temperature and centrifuging the suspension at about 14,000×g for about 10 minutes to form a supernatant and a solid residue,
(f) mixing the solid residue from (e) with water at temperatures in the range of about 75° C. to about 100° C. to form a suspension,
(g) subjecting the suspension from (f) to shearing at about 10,000 rpm for about 5 minutes, cooling the suspension to about room temperature and centrifuging the suspension at about 14,000×g for about 10 minutes to form a supernatant and a solid residue,
(h) mixing the solid residue from (g) with water at temperatures in the range of about 75° C. to about 100° C. and stirring for about 5 minutes to form a suspension,
(i) subjecting the suspension from (h) to a first shearing at about 20,000 rpm for about 5 minutes and subjecting the suspension to a second shearing at about 20,000 rpm for about 1 minute, cooling said suspension to about room temperature and centrifuging the suspension at about 14,000×g for about 10 minutes to form a supernatant and a solid residue,
(j) mixing the solid residue from (i) with water at temperatures in the range of about 75° C. to about 100° C. and stirring for about 5 minutes to form a suspension and subjecting the suspension to a first shearing at about 20,000 rpm for about 5 minutes and subjecting the suspension to a second shearing at about 20,000 rpm for about 1 minute, cooling the suspension to about room temperature and centrifuging the suspension at about 14,000×g for about 10 minutes to form a supernatant and a solid residue, and
(k) repeating step (j) until a clear supernatant is obtained and drying the final solid residue containing cellulosic arabinoxylan fiber to form dried cellulosic arabinoxylan fiber.

Agricultural processing byproducts (e.g., sorghum bran, corn bran, corn fiber, rice fiber, rice hulls, pea fiber, barley hulls, oat hulls, soybean hulls, sugar cane bagasse, sugar-beet bagasse, carrot pomace etc.) contain numerous components that could be valuable co-products if they could be economically isolated. Agricultural residues (e.g., corn stover, wheat straw, rice straw, barley straw etc.) and energy crops (e.g., sorghum bagasse, biomass sorghum, switchgrass, Miscanthus, etc.) may also be abundant and inexpensive sources for many valuable coproducts. Such Lignocellulosic materials rich in lignocellulose are abundant and renewable biological resources. These lignocellulosic materials are natural composites consisting of three main polymeric components: cellulose, hemicellulose, and lignin, as well as other minor components such as extractives (e.g., phenolics, lipids, etc.), pectin, or protein (Zhang, Y.-HL P., and L. R. Lynd, Biotechnol. Bioeng., 88: 797-824 (2004); Fengel, D., and G. Wegener, Wood: Chemistry, Ultrastructure, Reactions; Walter de Gruyter & Co., Berlin, 1984). Lignocellulosic byproducts are the source of many valuable bio-based products, which can be used in several industries. Fibers from lignocellulosic sources have various applications, such as building materials, particle board, human food, animal feed, cosmetics, medicine and many others (Reddy, N., and Y. Yang, Trends in Biotechnology, 23: 22-27 (2005)). It is becoming important to develop consumer products from the above mentioned renewable resources. The isolation of cellulose suitable for human consumption from agricultural processing byproducts (e.g., soy hulls, sugar beet pulps, pea hulls, corn bran, etc.) has been reported (U.S. Pat. No. 4,484,459; U.S. Pat. No. 5,057,334). Corn fiber/bran, a renewable resource available in huge quantities, can be a good source of valuable consumer products. Corn fiber makes up about 5 to 10 wt. % portion of the total weight of corn kernel. It is made up of a number of valuable components, which if extracted economically can be commercially valuable. Corn fiber consists primarily of residual starch (10 to 20 wt. %), hemicelluloses (40 to 50 wt. %), cellulose (15 to 25 wt. %), phenolic compounds (3 to 5 wt. %), protein (5 to 10 wt %), and some oils (Wolf, M. J., et al., Cereal Chemistry, 30, 451-470 (1953); Chanliaud, E., et al., J. Cereal Science, 21:195-203 (1995)). The variations in the fiber composition are believed to be due to corn plant variety and growth conditions as well as isolation methods used.

After removing the commercially valuable component “hemicelluloses” from, for example, corn fiber, the insoluble residue can be isolated, purified and its functionalities can be tested for commercial uses. Based on our studies, this residue, called “cellulosic arabinoxylan fiber” (CAF), has a unique water holding capacity and could be used, for example, as a food bulking agent and thickener.

### SUMMARY OF THE INVENTION

Processes for the preparation of cellulosic arabinoxylan fiber involving (a) mixing ground agricultural materials in water at temperatures in the range of about 75° C. to about 100° C. to form a suspension, adjusting the pH of said suspension from about 5.2 to about 6.8, and adding thermostable α-amylase to said suspension; (b) adjusting the pH of the suspension to about 11.5; (c) subjecting the suspension to shearing at about 10,000 rpm for about 1 hour and centrifuging the suspension at about 14,000×g for about 10 minutes to form a supernatant and a solid residue; (d) mixing the solid residue with water at temperatures in the range of about 75° C. to about 100° C. to form a suspension; (e) subjecting the suspension from (d) to shearing at about 10,000 rpm for about 5 minutes, cooling said suspension to about room temperature and centrifuging the suspension at about 14,000×g for about 10 minutes to form a supernatant and a solid residue; (f) mixing the solid residue from (e) with water at temperatures in the range of about 75° C. to about 100° C. to form a suspension; (g) subjecting the suspension from (f) to shearing at about 10,000 rpm for about 5 minutes, cooling the suspension to about room temperature and centrifuging the suspension at about 14,000×g for about 10 minutes to form a supernatant and a solid residue; (h) mixing the solid residue from (g) with water at temperatures in the range of about 75° C. to about 100° C. and stirring for about 5 minutes to form a suspension; (i) subjecting the suspension from (h) to a first shearing at about 20,000 rpm for about 5 minutes and subjecting the suspension to a second shearing at about 20,000 rpm for about 1 minute, cooling said suspension to about room temperature and centrifuging the suspension at about 14,000×g for about 10 minutes to form a supernatant and a solid residue; (j) mixing the solid residue from (i) with water at temperatures in the range of about 75° C. to about 100° C. and stirring for about 5 minutes to form a suspension and subjecting the suspension to a first shearing at about 20,000 rpm for about 5 minutes and subjecting the suspension to a second shearing at about 20,000 rpm for about 1 minute, cooling the suspension to about room temperature and centrifuging the suspension at about 14,000×g for about 10 minutes to form a supernatant and a solid residue; and (k) repeating step (j) until a clear supernatant is obtained and drying the final solid residue containing cellulosic arabinoxylan fiber to form dried cellulosic arabinoxylan fiber. Cellulosic arabinoxylan fiber prepared by the processes. Edible formulations, containing the cellulosic arabinoxylan fiber, wherein the cellulosic arabinoxylan fiber functions as bulking agents in the edible formulation. Methods of stabilizing an emulsion, involving mixing an effective stabilizing amount of the cellulosic arabinoxylan fiber with an emulsion to stabilize said emulsion. Methods of increasing the water holding capacity of a composition, involving mixing an effective water holding increasing amount of the cellulosic arabinoxylan fiber with a composition to increase the water holding capacity of said composition. Method of increasing the bulk of a composition, involving mixing an effective bulk increasing amount of the cellulosic arabinoxylan fiber with a composition to increase the water holding capacity of said composition. Methods of increasing the viscosity of a composition, involving mixing an effective viscosity increasing amount of the cellulosic arabinoxylan fiber with a composition to increase the viscosity of said composition.

This summary is provided to produce a selection of concepts in a simplified form that are further described below in the detailed description. This summary is not intended to identify key features or essential features of the claimed subject matter, nor is it intended as an aid in determining the scope of the claimed subject matter.

### BRIEF DESCRIPTION OF THE DRAWINGS

FIG. 1 shows a generic scheme for the preparation of cellulosic arabinoxylan fiber (CAF) as described below.

FIG. 2 shows the effects of shearing time on viscosity of 4% suspension of corn CAF sheared using a rotor-stator homogenizes at 15000 rpm as described below.

FIG. 3 shows the effect of multiple passes through a milk homogenizer at 4000 psi on the viscosity of a 1% suspension of corn CAF as described below.

FIG. 4 shows the effects of drying technique and shearing on corn CAF viscosity: Comparison of drum dried (DD) and spray dried (SD) CAF suspensions prepared with and without shear as described below.

FIG. 5 shows the effects of drying technique and shearing on sorghum CAF viscosity: Comparison of drum dried (DD) and spray dried (SD) CAF suspensions prepared with and without shear as described below.

### DETAILED DESCRIPTION OF THE INVENTION

Disclosed are processes for producing novel “cellulosic arabinoxylan fiber” (CAF) and mixtures using agricultural products and/or lignocellulosic agricultural by-products (e.g., corn bran/fiber or other bran/fiber samples such as oat bran, wheat bran, barley straw and hull, sugar cane bagasse, sugar-beet bagasse, corn stover, wheat straw, sorghum bran) and/or lignocellulosic energy crops (e.g., switchgrass and Miscanthus). The term “agricultural materials” is defined herein as including agricultural products, lignocellulosic agricultural by-products, and lignocellulosic energy crops, individually or as mixtures.

Cellulosic arabinoxylan fiber (CAF) can generally be prepared as follows: ground plant material (e.g., agricultural processing byproducts such as sorghum bran, corn bran, wheat bran, rice fiber, barley hulls, sugar cane bagasse, sugar-beet bagasse, carrot pomace; agricultural residues such as corn stover, wheat straw, barley straw) and energy crops such as switchgrass, Miscanthus) was added to mechanically stirred hot water (85° C.) The pH of the suspended material was adjusted, generally to about 5.2 to 6.8 (e.g., 5.2 to 6.8; preferably 5.8) by adding 50% sodium hydroxide solution, and α-amylase (Novozymes, Inc. Davis, Calif.) was added and stirred for about 1 hour to hydrolyze starch. The pH of the slurry was raised to about 11.5 by adding 50% sodium hydroxide and stirred using a mechanical stirrer at about 85° C. for about an additional 30 minutes to completely deconstruct the material. During the reaction, the pH was kept at 11.5 by adding more 50% NaOH and the reaction volume was maintained the same by adding water as needed to compensate for water loss due to evaporation. The slurry of the deconstructed material was transferred into a container and immediately sheared, while it was still hot, for example using a high speed mixer/homogenizer Polytron (PT 10/35 GT) equipped with 12 mm probe (Brinkman Instruments) at about 10,000 rpm for about 1 hour. The solid residue was separated from the reaction mixture by centrifugation at about 14,000×g for about 10 minutes, and then suspended in boiling water and stirred using a mechanical stirrer for about 5 minutes. The hot suspension was transferred into a container and sheared at about 10,000 rpm for about 5 minutes. The sheared material was allowed to cool to room temperature and centrifuged at about 14,000×g for about 10 minutes to separate the solid. The separated solid was further suspended into boiling water in a container and boiled for about 5 minutes with stirring using a mechanical stirrer. The hot suspension was again transferred into a container, sheared at about 10,000 rpm for about 5 minutes and centrifuged at about 14,000×g for about 10 minutes to collect the solid residue. The total solid residue was divided into two halves (since it was hard to process all material in one batch, so it was divided into two halves and each half was processed separately in the same way, and the final product from two halves were combined to calculate the final yield) and each half was processed to get a dry CAF as follows: One half of the solid material was suspended into boiling water, boiled for about 5 minutes with mechanical stirring, transferred into a container and sheared at about 20,000 rpm for about 5 minutes. Additional boiled water was added to this processed material and sheared again at about 20,000 rpm for about 1 minute. The solid was separated by centrifugation at about 14,000×g for about 10 minutes after cooling the hot sheared material to room temperature. The suspension of the solid material in hot water and its heating and shearing as above were repeated till a clear supernatant was seen. For most of the materials used, two repetitions (total three washings) were needed to obtain a clear supernatant. The final solid residue was collected, suspended into water to make slurry, and dried (e.g., drum or spray drying).

As noted above, after removing the commercially valuable component “hemicelluloses” from, for example, corn fiber, the insoluble residue can be isolated, purified and its functionalities can be tested for commercial uses. Based on our studies, this residue, called “cellulosic arabinoxylan fiber” (CAF), had a unique water holding capacity and could be used, for example, as a food bulking agent and thickener.

The CAF obtained during hemicellulose isolation from agricultural residues, agricultural processing byproducts and energy crops (such as sweet sorghum bagasse, biomass sorghum, switchgrass, miscanthus, etc.) had a similar water binding capacity leading to its application in the food industry as an insoluble dietary fiber and/or as a bulking agent. Such water-holding behavior of polymers is important for their functional roles in foods. Water holding capacity was closely linked to the nature of the gel network and its homogeneity, and there was much variation when comparing these cellulosic arabinoxylan materials from various sources of biomass. Such polymers have a significant market in food industries for making food gels. The term water-holding capacity is used to mean the amount of water retained by food materials in such a way that its exudation is prevented. The ability of fiber to hold water provides bulk and, when consumed, may cause a feeling of satiety without providing excessive calories. Thus in treating obesity, high fiber diets are recommended. Dietary fiber has also been shown to slow down gastric emptying and nutrient absorption may take place over a longer period. The water-holding capacity of dietary fiber has been proposed to be valuable in the diet to alter stool bulking (Gray, H., and M. L. Tainter, Am. J. Dig. Dis. 8: 130-139 (1941)). Increased stool weight can cause shorter gut transit times limiting the exposure of the gut to toxins (Faivre, J., et al., Eur. J. Cancer Prevent., 1: 83-89 (1991); Reddy, B. S., et al., Cancer Res., 49: 4629-4635 (1989)). The compounds considered dietary fiber are generally split into two groups: water soluble and water insoluble. Gums, pectins, mucilages and hemicelluloses fall into the category of soluble fiber. Cellulose and lignin are considered insoluble. Fiber ingredients come from a number of sources and typically contain a mixture of soluble and insoluble fiber. Most fiber ingredients, especially insoluble forms, are derived form plants: grains like corn, wheat, soy and oats; legumes; fruit; and even trees. Purified cellulose fibers derived from a variety of sources are commonly used in bulking and caloric-reduction applications, but other types of fibers may provide functional or physiological benefits. It is common to combine different sources of fiber to get the finished product characteristics we need. One of the main reasons is mouthfeel. Excess levels of one kind of fiber may produce an unacceptable “mouth feel” A bulking agent is an additive that contributes solids to provide texture/palatability and it increases the bulk of a food without affecting its nutritional value. Bulking agents are non-caloric additives used to impart volume and mass to a food. Water soluble dietary fibers (e.g., guar gum, xanthan gum, gum Arabic, carboxymethyl cellulose, other cellulose derivatives, etc.) are common forms of bulking agents. Gum arabic has been used in dietetic foods as a noncaloric bulking agent in special-purpose foods for diabetic. A mixture of gum arabic and xanthan gum has been used in the preparation of reduced-fat products such as butter, margarine, toppings, spreads, and frozen desserts. Bulking agents can be used to partially or completely replace high-caloric ingredients, such as sugar and/or flour, so as to prepare an edible formulation with a reduction in calories. Bulking agents are also useful as a source of soluble and/or insoluble fiber to be incorporated into foods and, unlike sucrose, are non-cariogenic, thus preventing tooth decay (U.S. Pat. No. 5,811,148; Voragen, A. G. J., Trends Food Sci. Technol., 9:328-335 (1998)). CAF is a bulking agent due to its high water holding capacity, it increases the volume of the product in which it is added but it does not provide calories.

The CAF produced by our processes was made without using hydrogen peroxide and by using high shear (e.g., about 10,00-20,000 rpm). The CAF was made from multiple feedstocks. The CAF had high water binding properties, different rheologies, and different antioxidative capacities.

This invention relates to substantially non-digestible bulking agents (i.e., CAF) for use in edible formulations and processes for preparing these agents. Bulking agents can be used to partially or completely replace high-caloric ingredients, such as sugar and/or flour so as to prepare an edible formulation with a reduction in calories. Also, the bulking agents are useful as a source of soluble fiber to be incorporated into foods and, unlike sucrose, are non-cariogenic. Among the edible formulations which may include the bulking agents are: baked goods; puddings, creams and custards; jams and jellies; confections; soft drinks and other sweetened beverages, in liquid or dry form; sauces and salad dressings; ice cream and frozen desserts; foods which are sweetened; tabletop sweeteners and pharmaceuticals. The bulking agents herein may be employed alone, or as mixtures, in any edible formulation. The nature of the edible formulation will direct the selection of an appropriate bulking agent from those disclosed herein. The edible formulation may be liquid or dry, may be heat processed or frozen or refrigerated, and may contain appropriate high potency sweeteners. The bulking agents are stable to the temperature, oxygen content, enzymatic activity and pH conditions normally observed in the manufacture and storage of foods, pharmaceuticals and other edible formulations.

Physical properties of CAF: CAF was characterized by surprisingly high water holding capacity, holding several grams of water per gram material (Table 3). For instance, CAF from corn bran held nearly 35 g of water per gram, while CAF prepared from barley straws held 21 g of water per gram. CAF suspensions surprisingly showed very high viscosity even at low concentrations. They also surprisingly showed shear thinning behavior (Table 5), which contributes to ease of processing since the material shows low viscosity during pumping in spite of the high viscosity at rest and at low shear rates. It is noteworthy that pumping itself did not cause the suspension to lose any viscosity, and the suspension was also stable over a wide range of temperature and pH values. The uniquely high water holding capacity and viscosity enables numerous food applications of CAF, such as in sauces, dressings, baked products, meat products, dairy products, etc. (Tables 8-15). In these and other food systems, CAF can help to build viscosity, replace fat, control moisture migration and impart freeze-thaw stability. CAF suspensions have a smooth, non-gritty texture, which makes them excellent fat replacers, helping in the development of reduced or zero calorie formulations that maintain the body and texture of the original product. CAF can also function as a good emulsion stabilizer in food systems such as meat products as well as non-food systems such as oil drilling fluids. The spray dried CAF surprisingly hydrated very easily, yielding very high viscosity without any shearing during suspension. Shearing this suspension increased the viscosity further. Thus spray dried CAF is surprisingly a shear-optional viscosity modifier which gives high ease of use in food and non-food systems.

Chemical properties of CAF: CAF was rich in non-digestible carbohydrates, with very low starch content (Table 2). This makes it a rich source of insoluble dietary fiber, enabling its potential use as a dietary fiber in food applications. The carbohydrate in CAF mainly consisted of glucose, xylose, and arabinose. The xylose and arabinose were present in the form of a highly branched arabinoxylan, with a β-1,4 linked xylan backbone. The glucose polymer was mainly β-1,4 linked, indicating a cellulose-like polymer. However, there was a surprising amount of branching present in the glucose polymer in corn bran CAF (Table 7a). Without being bound by theory, this implies that this polymer is significantly different from cellulose, marking a major departure from current understanding of corn bran composition. Without being bound by theory, the branching on the glucose polymer may be partly responsible for the high water holding capacity of the CAF since it would decrease polymer crystallinity and afford more sites for water binding than cellulose. CAF also had antioxidant capacity, as evidenced by the ORAC value (Table 4), which ranges from 326 μmole Trolox/100 g for CAF from barley straws to 1560 μmole Trolox/100 g for CAF from corn bran. This implies that CAF can offer significant health benefits as a source of antioxidants. Since CAF is prepared from natural lignocellulosic materials with no chemical modification of its constituent polymers, it is a natural, clean label additive.

Thus, the unique physical and chemical properties of CAF enable them to be used in a wide variety of food and non-food applications requiring wide-ranging functionalities, while also offering ease of use, consistency and clean labels for food products.

Unless defined otherwise, all technical and scientific terms used herein have the same meaning as commonly understood by one of ordinary skill in the art to which the invention belongs. As used herein, the term “about” refers to a quantify, level, value or amount that varies by as much as 30%, preferably by as much as 20%, and more preferably by as much as 10% to a reference quantity, level, value or amount. Although any methods and materials similar or equivalent to those described herein can be used in the practice or testing of the present invention, the preferred methods and materials are now described.

The following examples are intended only to further illustrate the invention and are not intended to limit the scope of the invention as defined by the claims.

### EXAMPLES

Preparation of cellulosic arabinoxylan fiber (CAF): 200 g of ground plant material (e.g., agricultural processing byproducts such as sorghum bran, corn bran, wheat bran, rice fiber, barley hulls, sugar cane bagasse, sugar-beet bagasse, carrot pomace; agricultural residues such as corn stover, wheat straw, barley straw) and energy crops such as switchgrass, miscanthus) was added to mechanically stirred 1150 mL hot water (85° C.) in a 4 L beaker. The pH of the suspended material was adjusted, generally to about 5.2 to 6.8 (e.g., 5.2 to 6.8; preferably 5.8) by adding 50% sodium hydroxide solution, and 2 g of α-amylase (Novozymes, Inc. Davis, Calif.) was added and stirred for 1 hour to hydrolyze starch. The pH of the slurry was raised to 11.5 by adding 31.4 mL of 50% sodium hydroxide and stirred using a mechanical stirrer at 85° C. for an additional 30 minutes to completely deconstruct the material. During the reaction, the pH was kept at 11.5 by adding more 50% NaOH and the reaction volume was maintained the same by adding water as needed to compensate for water loss due to evaporation. The slurry of the deconstructed material was transferred into a 4 L plastic beaker and immediately sheared, while it was still hot, using a high speed mixer homogenizer Polytron (PT 10/35 GT) equipped with 12 mm probe (Brinkman Instruments) at 10,000 rpm for 1 hour. The solid residue was separated from the reaction mixture by centrifugation at 14,000×g for 10 minutes, and then suspended in 2 L boding water and stirred using a mechanical stirrer for 5 minutes. The hot suspension was transferred into a 4 L plastic beaker and sheared at 10,000 rpm for 5 minutes. The sheared material was allowed to cool to room temperature and centrifuged at 14,000×g for 10 minutes to separate the solid. The separated solid was further suspended into 2 L boiling water in a 4 L glass beaker and boiled for 5 minutes with stirring using a mechanical stirrer. The hot suspension was again transferred into 4 L plastic beaker, sheared at 10,000 rpm for 5 minutes and centrifuged at 14,000×g for 10 minutes to collect the solid residue. The total solid residue was divided into two halves (since it was hard to process all material in one batch, so it was divided into two halves and each half was processed separately in the same way, and the final product from two halves were combined to calculate the final yield) and each half was processed to get a dry CAF as follows: One half of the solid material was suspended into 2 L boiling water, boiled for 5 minutes with mechanical stirring, transferred into a plastic beaker and sheared at 20,000 rpm for 5 minutes. Additional 2 L boiled water was added to this processed material and sheared again at 20,000 rpm for 1 minute. The solid was separated by centrifugation at 14,000×g for 10 minutes after cooling the hot sheared material to room temperature. The suspension of the solid material in hot water and its heating and shearing as above were repeated till a clear supernatant was seen. For most of the materials used, two repetitions (total three washings) were needed to obtain a clear supernatant. The final solid residue was collected, suspended into water to make slurry, and dried (e.g., drum or spray drying).

Carbohydrate composition and linkage: The sugar composition of CAF samples was determined by the following NREL Method (Laboratory Analytical Procedure 2008, Determination of Structural Carbohydrates and Lignin in Biomass). In brief, 0.3 g sample was suspended in 3 mL 72% (w/w) sulfuric acid in a test tube, mixed and incubated at 30° C. for 1 h with stirring at every 5 to 10 minutes. The sample suspension was transferred into a 100 mL Pyrex® glass bottle by using 84 mL water, which also diluted the acid to 2.48%. At this time standard sugar solutions were prepared by taking 0.1 g of each sugar in a Pyrex® bottle and adding 10 mL water and 348 uL 72% sulfuric acid to it, which made the final acid concentration 2.42%. The bottles containing samples and standard sugars were capped and placed in an autoclave at 121° C. for 1 h. After cooling to room temperature, an aliquot of 5 ml was taken from each autoclaved sample; its pH was adjusted between 5 and 7 by adding calcium carbonate and centrifuged (using a table top centrifuge at 13,000 rpm for 3.5 minutes) to remove the precipitated calcium sulfate. The supernatant was filtered by using Acrodisc LC 13 mm syringe filter (0.2 μm to remove any remaining solids and the filtrate was analyzed for sugars by Agilent 1200 HPLC that included a BioRad Aminex HPX-87H column at 60° C. and an Refractive Index (RI) detector. The mobile phase consisted of isocratic 5 mM H₂SO₄ eluant for 25 minutes, followed by a 5 min purge with the same eluant to clean RI detector to avoid base line drift prior to the next injection, at a flow rate of 0.6 ml/min. Sugars were quantified by using a calibration curve of standard sugars prepared with the same conditions.

The glycosyl linkage composition was determined by gas chromatography-mass spectrometry (GC-MS) method. For this analysis, the sample was permethylated, depolymerized, reduced and acetylated. The resulting partially methylated alditol acetate (PMAAs) was analyzed by GC-MS as described by York et al., Methods Enzymol., 118: 3-40 (1986).

Water holding capacity: The water holding capacity of CAF was determined according to AACC method 88-04 (AACC, 1995) with some modification. Briefly, 0.5 g CAF sample was weighed in a polypropylene centrifuge tube with screw cap. To each tube, 24.5 mL distilled water were added and the sample was sheared using a high speed Polytron at 10,000 rpm for 2 minutes and at 15,000 rpm for 1 minute. The tubes were placed on a shaker at room temperature and shaken at a moderate speed (e.g., about 160 rpm) for about 24 hours. Then they were centrifuged at 1,500×g for 15 minutes or 14,000×g for 1 h, excess water was decanted, and tubes were inverted to completely decant any residual water. Each tube was weighed. The amount of water held was calculated by subtracting the weight before water treatment and reported as gram of water adsorbed per gram of sample.

Antioxidant activity: Highly reactive molecules like free radicals and reactive oxygen species are generated by normal cellular processes in the body, UV irradiation, and environmental stresses. These reactive molecules react with cellular components damaging DNA, carbohydrates, proteins, and lipids, causing injury to cells and tissues. Excess production of such reactive species can cause several diseases including cancer, diabetes, and atherosclerosis, etc. Most mammals have antioxidant systems to protect themselves from oxidative stress; however, an excess of free radical and/or reactive oxygen species can cause severe damage. One way to measure the antioxidant power of compositions, foods, and plant phytochemicals is to determine the Oxygen Radical Absorbance Capacity (ORAC) value of the composition. The ORAC antioxidant assay measures the loss of fluorescein over time due to peroxyl-radical formation by the breakdown of 2,2-azobis-2-methyl-propanimidamide, dihydrochloride (AAPH). Trolox, which is a water soluble vitamin E analog, serves as a positive control inhibiting fluorescein decay in a dose dependent manner. The ORAC assay is a kinetic assay measuring fluorescein decay and antioxidant protection over time. The antioxidant activity can be normalized to equivalent Trolox units to quantify the composite antioxidant activity present. This assay measures the material's antioxidant activity by hydrogen atom transfer. The higher ORAC score of a material is an indication of its, greater antioxidant capacity. The antioxidant activity was tested by measuring an ORAC values by a commercial laboratory using the following published procedures with some modification: Huang, D., et al., J. Agric. Food Chem., 50: 1815-1821 (2002); and Ou, B., et al., J. Agric. Food Chem., 50: 3122-3128 (2002).

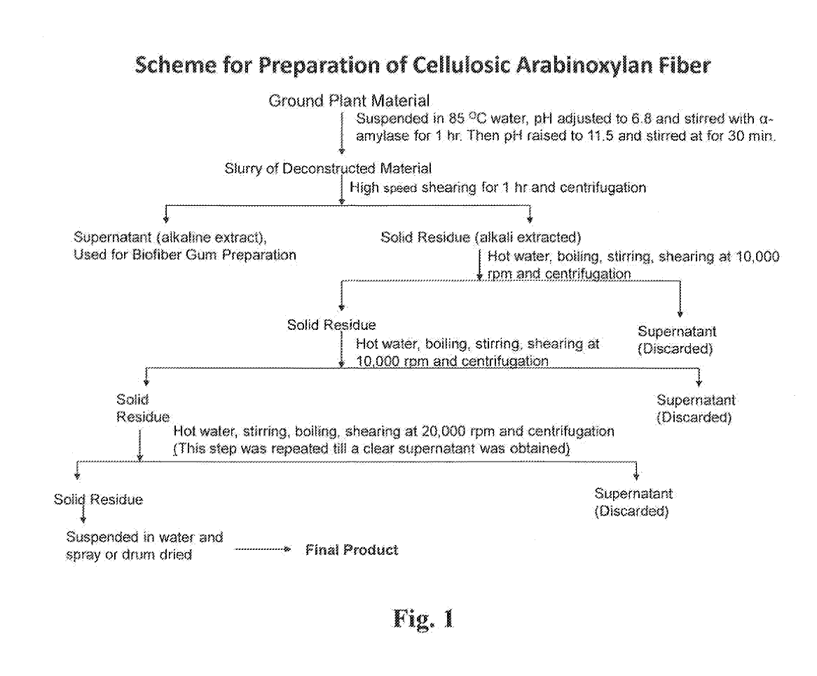

FIG. 1 shows the generic scheme for the isolation, purification and drying of CAF.

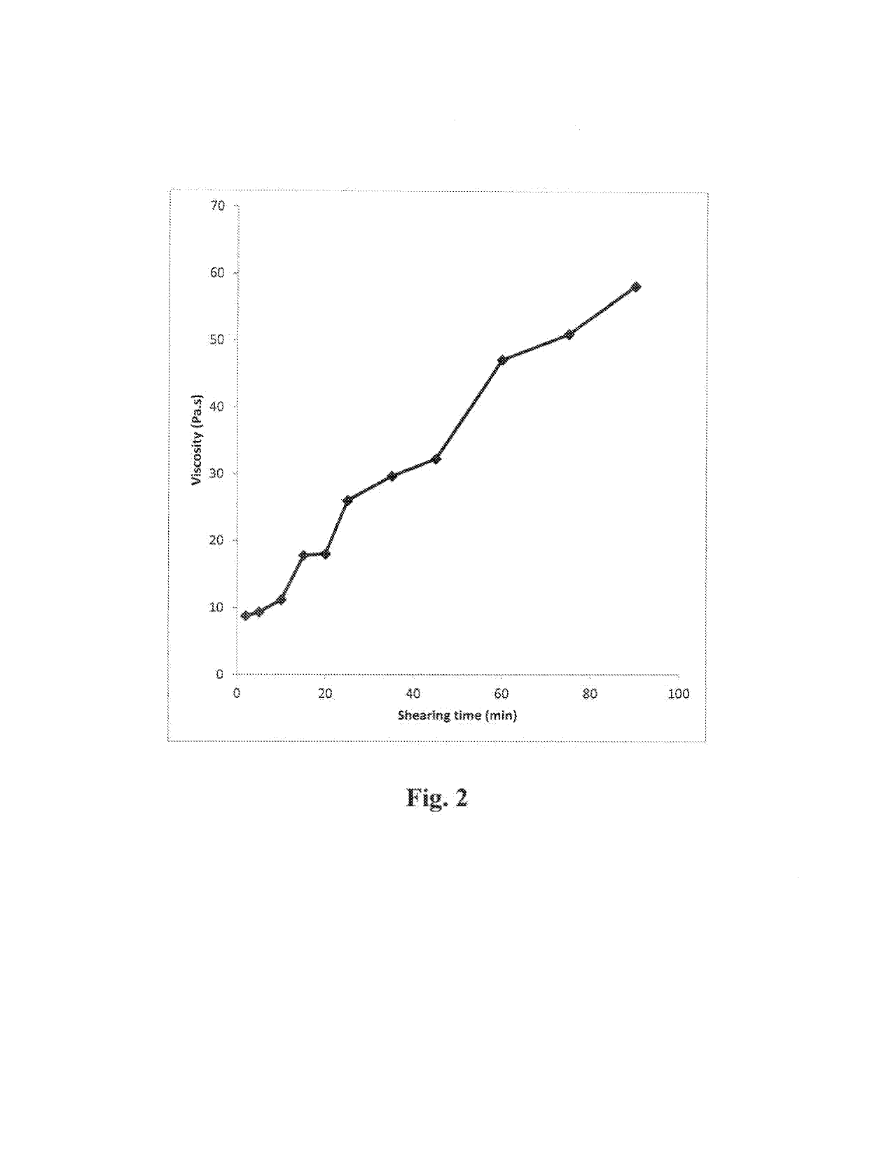

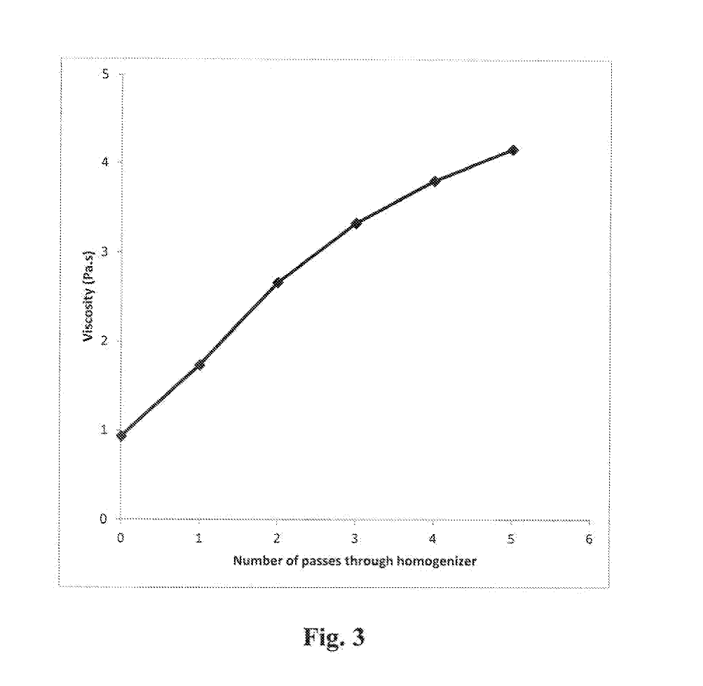

FIG. 2 illustrates the effect of shearing time on the viscosity of a 4 % corn bran CAF suspension. The sample used for this experiment had been drum dried and did not show high viscosity with no shear. However, as the suspension was sheared using a rotor-stator homogenize at 15000 rpm for longer time, its viscosity surprisingly increased significantly. Without being bound by theory, this may be a result of particle size reduction and greater swelling of the particles due to shearing, leading to more water binding and an increase in the volume occupied by the CAF particles. A similar effect was observed by using a milk homogenizer at a pressure 4000 psi in lieu of the rotor-stator homogenizer. In this case, as shown in FIG. 3, the viscosity of a 1% suspension of corn CAF surprisingly increased significantly with increasing number of passes through the homogenizer. The use of a milk homogenizer for increasing the viscosity of the CAF suspension offers the major advantage of scalability. In situ heat generation during the processing also helps to sterilize the product and prevent microbial growth. The fact that viscosity increased after each additional pass through the homogenizer or with increasing shearing time with the rotor-stator was quite surprising and illustrates the uniqueness of the CAF product. Most other viscosifying materials tend to be thixotropic in nature, and show a decrease in viscosity on being exposed to such high shear, due to loss of particle structure. Thus, this surprising increase in viscosity of CAF upon greater shearing is a unique characteristic of this product.

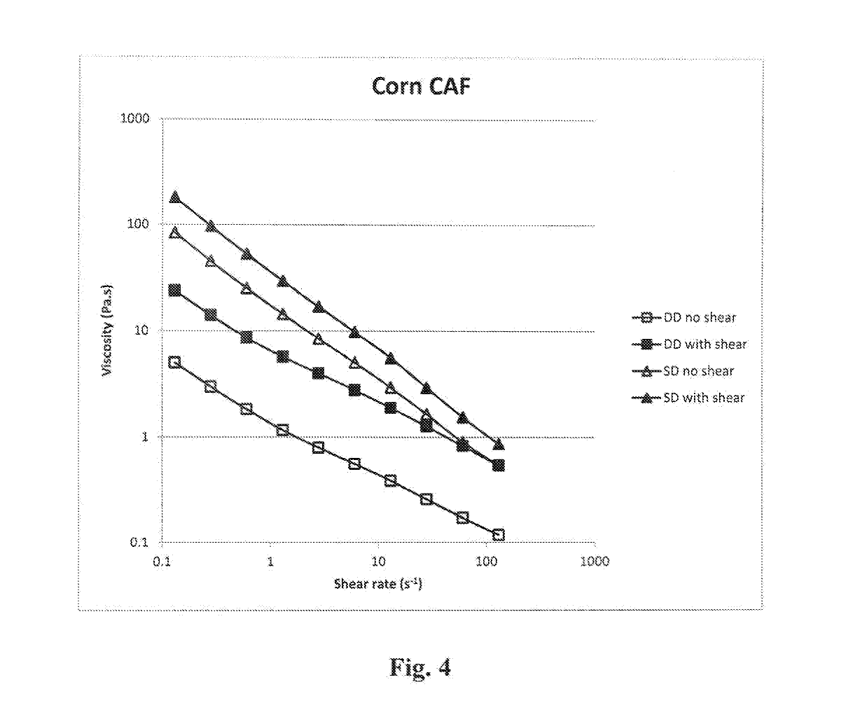

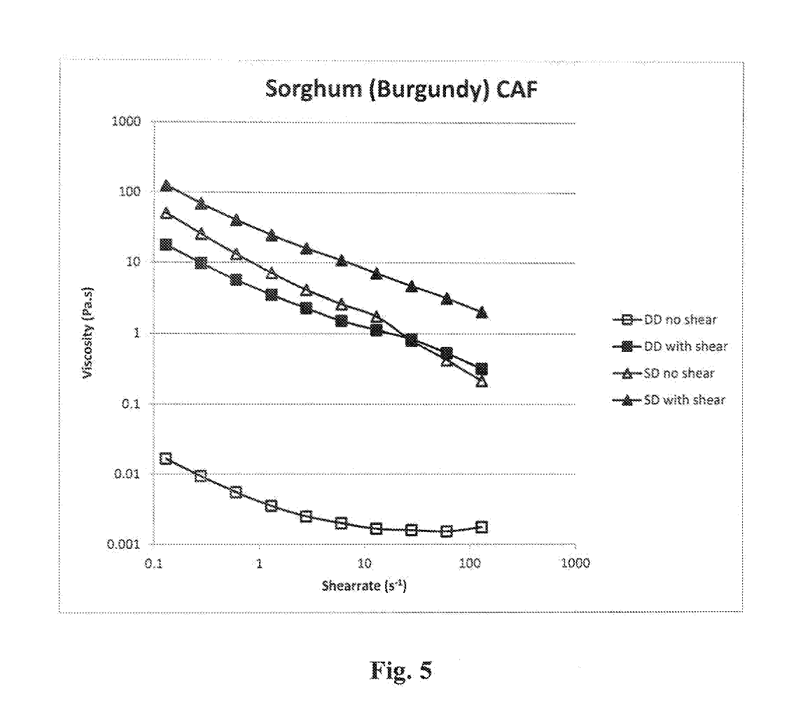

FIGS. 4 and 5 show comparisons of the flow behavior of 4 % suspensions of drum dried and spray dried CAF from corn bran and Burgundy sorghum bran, prepared with and without shearing at 15000 and 10000 rpm. The viscosity was measured at shear rates between 0.13 and 130 s⁻¹. It is clear that, in both cases, the drum dried CAF did not show high viscosity when prepared without any shearing (empty squares). When these samples were sheared for 3 minutes at 15000 rpm followed by 2 minutes at 10000 rpm, the viscosity surprisingly increased significantly (filled squares). The spray dried CAF from both sources surprisingly showed high viscosity (equivalent to drum dried samples with shear) even without shearing (empty triangles). It must be noted that all samples were allowed to hydrate for at least 3 hours before measurement of viscosity. When the spray dried samples were sheared, the viscosity surprisingly increased even further (filled triangles). Thus it is clear that the drum dried CAF samples required shearing along with hydration in order to give high viscosity. Spray dried samples, on the other hand, surprisingly showed high viscosity even with no shearing if they were allowed to hydrate sufficiently. Shearing these samples surprisingly leads to even higher viscosities which cannot be obtained with drum dried samples at this level of shearing.

Table 1 shows the amount of CAF isolated from different plant materials, following the scheme given in FIG. 1, varied from 14.30 to 59.90%. There was a significant range of yields of CAF from these plant materials. The rice fiber had the highest percent of CAF but had been previously treated by its manufacturer, which may have resulted in the high level of CAF. Corn stover, wheat straw, Miscanthus, sugarcane bagasse, and barley straw have more than 40% CAF and so they were all promising feedstocks for commercial scale production. The remaining plant materials had less than 20% yield, but could be used for CAF production if they are readily available.

Table 2 shows the ash content of CAF isolated from all sources was less than 3% except corn stover (7.29%) and sugarcane bagasse (9.90%). Their protein content varied from 0.56 to 2.20 except CAF from sorghum, which was rich in protein (5.37 to 23.82%). CAF from sorghum bran had 0.91 to 5.42% residual starch but from all other sources the starch content was less than 0.36%. They all had either zero or very small amounts (less than 0.5%) of crude fat. As names (cellulose rich arabinoxylan fiber), they were very rich in neutral detergent fiber (95.50 to 99.75%) except from sorghum due to some residual starch present in it. More than 90% of the fiber present was insoluble dietary fiber (except from Black and Sumac Sorghum bran). CAF from corn bran, corn stover, sorghum bran (black milled), sorghum bran (burgundy milled), barley hulls/straws and carrot pomace showed some soluble dietary fiber which can be due to presence of some water soluble carbohydrate. It is quite clear from this table that CAF isolated from all these plant materials were almost pure dietary fiber, will be non-caloric in human diets, and will be very useful for making non-caloric food products.

Table 3 shows the term water holding capacity (WHC), which was used to indicate the amount of water that the dietary fiber or any food material can retain. This property varied in the fibers isolated from different sources depending upon its carbohydrate composition, branching and molecular structure. The WHC in dietary fiber is considered to be valuable for many useful applications. The ability of fiber to hold water provided bulk and may cause feeling of satiety without providing calories. Such property of fiber has been proposed to be valuable in the diet to alter stool bulking causing shorter gut transit times limiting exposure of the gut to bile acids and toxins. A fiber with a high WHC makes it an ideal ingredient to add in many food products to increase its volume without changing its texture and reducing calories per serving. As shown in Table 3, there was a remarkable variation in the WHC of CAF depending upon it source and also the process of drying from its slurry into solid form. The usual way to study the water holding behavior of fiber is to dissolve it in water, mix overnight and centrifuge at about 100×g for a short time (about 15 minutes). But these samples were also tested by centrifuging at a very high speed (14,000×g) for a longer period of time (1 h) to study their capacity to hold water even in very strong conditions for separating water from fiber. The WHC of these fibers varied from 6.374 to a surprising 34.81 g/g (water/fiber) by centrifugating them at 1,000×g for 15 minutes and from 4.97 to 15.397 g/g (water/fiber) by centrifuging at a higher speed (14,000×g) for 1 hour. In both conditions, the WHC of CAF from corn bran was surprisingly higher than the CAF from all other sources, suggesting a dramatic difference in their structures and branching. The drying process to make CAF also has a surprising effect on its WHC as seen in drum and spray dried material form corn bran. The WHC of spray dried CAF from corn bran was higher (34.81 and 15.397 at lower and higher centrifugation speed respectively) than the drum dried product (32.767 and 13.922 at lower and higher centrifugation speed respectively) showing a remarkable effect of the drying method used. At low speed and shorter centrifugation time, the WHC of CAF from both rice fiber and rice bran was low (6.374 and 5.036 respectively). But the WHC of CAF from other plant materials was higher, falling in the range of 13.845 to 34.81.

Antioxidants terminate oxidation reactions in a food matrix or cell by donating hydrogen atoms or electrons, which are called reduction reactions. Phenolic compounds are a common antioxidant coming from the diet that breaks free radical chain reactions. In this study, the antioxidant activity was measured by ORAC assay, which is presented in Table 4. The ORAC assay was based on the principle that antioxidant compounds will prevent the production of peroxyl radicals. ORAC value is a measure of a compound's ability to delay the loss of fluorescence intensify over time. CAF isolated from all plant materials retained a considerable amount of phenolic compounds showing the ORAC antioxidant activity in the range of 326 to 1560 μmole Trolox/T100 gram sample. The sugar composition, linkages and structural features of polysaccharides may also influence their antioxidant properties (Lo et al., Carbohydrate Polymers, 86: 320-327 (2010); Chattopadhyay, et al., Food Chemistry, 118: 823-829 (2010); Rao, et al., Phytochemistry, 67: 91-99 (2006)). Thus arabinose in the side chain and unsubstituted and/or monosubstituted xylose might have antioxidant activities. The drum dried CAF from corn bran had the highest ORAC value of 1560 Trolox/100 gram. Surprisingly, drum dried corn bran's CAF had comparatively higher ORAC value than the spray dried material from the same source, showing the effect of drying method on ORAC value. The reason for this is unknown but may be related to the retention or accessability of phenolic compounds on the fiber. CAF from wheat bran, sorghum brans, switchgrass, barley hulls and rice fiber also had ORAC value above 600 μmole Trolox/100 gram. The ORAC value in the CAF from the remaining materials was less than 500 μmole Trolox/100 gram, which was still a high amount from the nutraceutical point of view. Thus the product of this invention (CAF) has the ability to provide antioxidant activity in the diet as well as health-promoting dietary fiber. Such properties in foods are believed to play a role in preventing the development of chronic diseases such as cancer, heart disease, stroke, Alzheimer's disease, Rheumatoid arthritis, and cataracts.

Table 5 summarizes the rheological properties of CAF from different biomasses. All the samples showed shear thinning behavior, with viscosity (at shear rate of 1 s⁻¹) between 400-29000 times that of water. Spray dried corn bran CAF showed the highest viscosity, followed by CAF from sugar-beet bagasse and carrot pomace. Rice fiber and barley hull CAF showed the lowest viscosity, in agreement with their relatively low water holding capacity, as seen in Table 4.

The Power Law model of rheological behavior was used to fit the flow behavior data. The model describes the flow behavior of the material in terms of the equations below, where σ represents the shear stress, \dot{γ} is the shear rate, η is the apparent viscosity and k and n are parameters.

$$σ = k {\dot{γ}}^{n}$$

$$η = \frac{σ}{\dot{γ}} = \frac{k {\dot{γ}}^{n}}{\dot{γ}} = k {\dot{γ}}^{n - 1}$$

The parameters of the Power Law model, calculated by fitting the apparent viscosity versus shear rate data, are good indicators of flow behavior of the material. The parameter ‘k’, which is called the flow consistency index, is a measure of the viscosity of the material at low shear rates, while ‘n’, which is the flow behavior index indicates how the viscosity changes as shear rate is increased. High values of k indicate that the material is thicker and more viscous at very low shear rates. Flow behavior index (n) values greater than 1 indicate that viscosity increases with shear rate, while values less than 1 indicate shear thinning behavior.

The flow behavior data for each CAF was fitted using the Power Law model, and values of flow consistency index (K) and flow behavior index (n) were calculated (Table 5). Spray dried corn bran CAF showed the highest K value, which is in line with its high apparent viscosity at 1 s⁻¹, as discussed before. Also, as expected from the apparent viscosity data, barley hull CAF showed the lowest flow consistency index value. For all the CAF samples, n values are less than 1, indicating shear-thinning behavior. The differences between actual values were illustrative of the extent of shear thinning. Spray dried corn bran CAF showed the lowest n value of 0.25 (and thus greatest decrease in viscosity with increase in shear rate), while the drum dried corn bran CAF showed the highest n value (0.50). This data implies that, while all the different CAFs were capable of providing very high viscosity at low shear rates, the viscosity decreased significantly when the materials encountered very high shear rates, such as during pumping which could be a valuable property during manufacturing and packaging.

Table 6 shows that the sugars present in CAF from all plant materials were glucose, xylose and arabinose, showing a typical cellulosic arabinoxylan structure. This was surprising since previous alkali-treated, insoluble products derived from corn bran and biomass sources were assumed to be purified cellulose, and contained primarily glucose with little to no arabinose and xylose. Also, the rigorous purification process used (FIG. 1) would be expected to remove all soluble arabinoxylan from the insoluble cellulosic materials. Table 6 shows, however, they contained about 34.78-73.87% glucose, 11.69-31.97% xylose, and 2.04-13.17% arabinose with total carbohydrate content varying from 70.85 to 96.83%. Thus, even with this level of extreme purification, measurable amounts of arabinose and xylose were present and under no circumstances were a pure “cellulose” prepared by these methods. The true structure of this Cellulosic Arabinoxylan Fiber is not known at this time. It could possibly be composed of sections of pure cellulose that entraps sections of pure arabinoxylan. Alternatively, it is not known whether cellulose and arabinoxylan polymers may be very strongly associated or covalently linked but together they make this fibrous material. A third possibility is that the CAF is made up of unique polysaccharides that contain both linear glucan regions and branched arabinoxylan regions. Regardless of the case, these materials represented novel fibrous materials not previously described.

Table 7(a) shows glycosyl linkage analysis results for CAF from corn bran, which demonstrated that it contained about 55.5% of (1→4)-linked glucose residues. This finding clearly showed that the major portion of this carbohydrate polymer was cellulose. It also clarified that it was not 100% cellulose but also contained xylose, arabinose and galactose. It looked like most of Xylp is present as (1→4)-linked backbone, which was highly branched on its 2, 3 position. The total percent of unbranched and branched (1→4) linked Xylp was 17.4% but only 5.2% of Xylp was present in the terminal position. A presence of high percent of arabinose, xylose, galactose and glucose (5.1, 5.2, 2.1 and 6.1% respectively) in the terminal position was a very good indication that it had a very highly branched structure. From these data, it is still not clear that whether (1→4)-linked Xylp backbone is covalently linked to (1→4)-linked glucose or it is very strongly associated due to its highly branched structure. But it was obvious that CAF contained a mixture of glucose- and xylose polymers, which were very branched and some other sugars were present in their side chains and terminal positions.

Table 7 (b, c, d and e) show the glycosyl linkage analysis results for CAF from rice fiber, wheat straw, Miscanthus and sugarcane bagasse. The results demonstrated that they contained about 53.3 to 66.8% of (1→4)-linked glucose residue and about 23.7 to 32.8% of (1→4) linked Xylp residue as the major sugars. This finding clearly showed that as in CAF from corn bran (7a), the major portion of this carbohydrate polymer in all these CAF samples had cellulose like sugar backbone. It also demonstrated very clearly that though it had a cellulose like sugar backbone, it did not have a fully cellulose like structure. It also contained a high percentage (23.7 to 32.8%) of xylan in addition to glucose and a few percent of arabinose. Unlike CAF from corn bran, the Xylp present as (1→4)-linked backbone in CAF from all these four sources were not highly branched as indicated by their low percent of terminal arabinose, xylose and glucose. The percent of sugars linked at 2, 3 or 6 position in all of these four samples were lower than CAF from corn bran (FIG. 7a), which former confirmed that they did not have a very highly branched structure. From these results, it is still not clear, whether the main two carbohydrate polymers [(1→4)-linked Xylp and (1→4)-linked glucose were covalently linked to each other or if they were just very strongly associated.

Table 7(f) shows the glycosyl linkage analysis results for CAF from carrot pomace, which differs from the glycosyl linkages of CAF isolated not only from corn fiber (Table 7a) but also from rice fiber, wheat straw, Miscanthus and sugarcane bagasse (Table 7b, c, d and e). It contained a high percentage of (1→4)-linked glucose residues (67.8%) like CAF from other biomasses mentioned above. But its (1→4)-linked Xylp content (5.1%) was lower than CAF from other sources. As CAF from rice fiber, wheat straw, Miscanthus and sugarcane bagasse, it had low percent of terminal sugars and less sugars linked at 2, 3 and 6 positions showing a ess branched structure than CAF from corn bran.

Table 8, Benefits: Ease of use, no need to be prehydrated; high water holding capacity: equates to moisture control, reduces staling and cost reduction; cost neutral/cost savings due to additional water that is able to be bound; suitable for fresh baked, frozen par baked and fully baked products; reduces fat and calorie content with equal batter viscosity, height and cell structure compared to control; strengthen and add flexibility to fragile baked goods or snacks; provide clean and natural label as corn fiber or oat fiber.

Table 9, benefits: high water holding capacity: equates to increase increased yield, control syneresis and act as a thickener; cost neutral/cost saving due to additional water that is able to be bound; replaces oils to reduce cost, improves nutritional values and mimics the mouth feel of fat; shear stable and so does not break down or lose viscosity through pumping, adds body and creaminess; stabilizes emulsions and suspends particulates; tolerant to low pH, heat stable and freeze/thaw stable; clean and natural label as corn fiber.

Table 10, benefits: ease of use, no need to be prehydrated; controls moisture, reduces shrinkage and improves yield; freeze/thaw stable, retains emulsion of fat and water during freezing and cooking for a better eating qualities; cost effective extender and binder that increases yield in meat applications; improves texture and mouthfeel, no gel like or undesirable textures; fat deflection in breaded fried foods; clean and natural label as corn bran isolated ingredient.

Table 11, benefits: ease of use, no need to be prehydrated; high water holding capacity, equates to texture control and act as a thickener; cost neutral/cost saving due to additional water that is able to be bound; replaces oils to reduce cost, improves nutritional values and mimics the mouth feel of fat; shear stable and so does not break down or lose viscosity through pumping, adds body and creaminess; stabilizes emulsions, suspends particulates and improves cling; tolerant to low pH, heat stable and freeze/thaw stable; clean and natural label as corn fiber.

The cellulosic Arabinoxylan fiber was produced from multiple biomass feedstocks and without hydrogen peroxide, and spray drying gave a more functional product. Products made using CAF had higher water binding properties. Products made using CAF had different rheology compared to products prepared by U.S. Pat. No. 5,766,662. Products using CAF had antioxidative capacity.

All of the references cited herein, including U.S. Patents, are incorporated by reference in their entirety. Also incorporated by reference in its entirety is U.S. Pat. No. 5,811,148.

Thus, in view of the above, there is described (in part) the following:

A process for the preparation of cellulosic arabinoxylan fiber comprising (or consisting essentially of or consisting of):
(a) mixing ground agricultural materials in water at temperatures in the range of about 75° C. to about 100° C. (e.g., about 85° C.) to form a suspension, adjusting the pH of said suspension from about 5.2 to about 6.8, and adding thermostable α-amylase to said suspension,
(b) adjusting the pH of said suspension to about 11.5,
(c) subjecting said suspension to shearing at about 10,000 rpm for about 1 hour and centrifuging said suspension at about 14,000×g for about 10 minutes to form a supernatant and a solid residue,
(d) mixing said solid residue with water at temperatures in the range of about 75° C. to about 100° C. to form a suspension,
(e) subjecting said suspension from (d) to shearing at about 10,000 rpm for about 5 minutes, cooling said suspension to about room temperature and centrifuging said suspension at about 14,000×g for about 10 minutes to form a supernatant and a solid residue,
(f) mixing said solid residue from (e) with water at temperatures in the range of about 75° C. to about 100° C. to form a suspension,
(g) subjecting said suspension from (f) to shearing at about 10,000 rpm for about 5 minutes, cooling said suspension to about room temperature and centrifuging said suspension at about 14,000×g for about 10 minutes to form a supernatant and a solid residue,
(h) mixing said solid residue from (g) with water at temperatures in the range of about 75° C. to about 100° C. and stirring for about 5 minutes to form a suspension,
(i) subjecting said suspension from (h) to a first shearing at about 20,000 rpm for about 5 minutes and subjecting said suspension to a second shearing at about 20,000 rpm for about 1 minute, cooling said suspension to about room temperature and centrifuging said suspension at about 14,000×g for about 10 minutes to form a supernatant and a solid residue,
(j) mixing said solid residue from (i) with water at temperatures in the range of about 75° C. to about 100° C. and stirring for about 5 minutes to form a suspension and subjecting said suspension to a first shearing at about 20,000 rpm for about 5 minutes and subjecting said suspension to a second shearing at about 20,000 rpm for about 1 minute, cooling said suspension to about room temperature and centrifuging said suspension at about 14,000×g for about 10 minutes to form a supernatant and a solid residue, and
(k) repeating step (j) until a clear supernatant is obtained and drying the final solid residue containing cellulosic arabinoxylan fiber to form dried cellulosic arabinoxylan fiber.

The above process, comprising (or consisting essentially of or consisting of):
(a) mixing ground agricultural materials in water at about 85° C. to form a suspension, adjusting the pH of said suspension from about 5.2 to about 6.8, and adding thermostable α-amylase to said suspension and stirring about 1 hour,
(b) adjusting the pH of said suspension to about 11.5 and stirring said suspension for about 30 minutes,
(c) subjecting said suspension to shearing at about 10,000 rpm for about 1 hour and centrifuging said suspension at about 14,000×g for about 10 minutes to form a supernatant and a solid residue,
(d) mixing said solid residue with water at temperatures in the range of about 75° C. to about 100° C. and stirring for about 5 minutes to form a suspension,
(e) subjecting said suspension from (d) to shearing at about 10,000 rpm for about 5 minutes, cooling said suspension to about room temperature and centrifuging said suspension at about 14,000×g for about 10 minutes to form a supernatant and a solid residue,
(f) mixing said solid residue from (e) with water at temperatures in the range of about 75° C. to about 100° C. and stirring for about 5 minutes to form a suspension,
(g) subjecting said suspension from (f) to shearing at about 10,000 rpm for about 5 minutes, cooling said suspension to about room temperature and centrifuging said suspension at about 14,000×g for about 10 minutes to form a supernatant and a solid residue,
(h) mixing said solid residue from (g) with water at temperatures in the range of about 75° C. to about 100° C. and stirring for about 5 minutes to form a suspension,
(i) subjecting said suspension from (h) to a first shearing at about 20,000 rpm for about 5 minutes and subjecting said suspension to a second shearing at about 20,000 rpm for about 1 minute, cooling said suspension to about room temperature and centrifuging said suspension at about 14,000×g for about 10 minutes to form a supernatant and a solid residue,
(j) mixing said solid residue from (i) with water at temperatures in the range of about 75° C. to about 100° C. and stirring for about 5 minutes to form a suspension and subjecting said suspension to a first shearing at about 20,000 rpm for about 5 minutes and subjecting said suspension to a second shearing at about 20,000 rpm for about 1 minute, cooling said suspension to about room temperature and centrifuging said suspension at about 14,000×g for about 10 minutes to form a supernatant and a solid residue, and
(k) repeating step (j) until a clear supernatant is obtained and drying the final solid residue containing cellulosic arabinoxylan fiber to form dried cellulosic arabinoxylan fiber.

The above process, wherein said drying in (k) is spray drying or drum drying.

Cellulosic arabinoxylan fiber prepared by the above process.

An edible formulation, comprising the cellulosic arabinoxylan fiber prepared by the above process, wherein said cellulosic arabinoxylan fiber functions as bulking agents in the edible formulation.

A method of stabilizing (preventing oil droplets from colliding with each other (coalescence) to form larger droplets and separate from the solution making oily layer at the top) an emulsion, comprising (or consisting essentially of or consisting of) mixing an effective stabilizing amount of the cellulosic arabinoxylan fiber produced by the above process with an emulsion to stabilize said emulsion.

A method of increasing the water holding capacity of a composition, comprising (or consisting essentially of or consisting of) mixing an effective water holding increasing amount of the cellulosic arabinoxylan fiber produced by the above process with a composition to increase the water holding capacity of said composition.

A method of increasing the bulk of a composition, comprising (or consisting essentially of or consisting of) mixing an effective bulk increasing amount of the cellulosic arabinoxylan fiber produced by the above process with a composition to increase the water holding capacity of said composition.

A method of increasing the viscosity of a composition, comprising (or consisting essentially of or consisting of) mixing an effective viscosity increasing amount of the cellulosic arabinoxylan fiber produced by the above process with a composition to increase the viscosity of said composition.

Other embodiments of the invention will be apparent to those skilled in the art from a consideration of this specification or practice of the invention disclosed herein. It is intended that the specification and examples be considered as exemplary only, with the true scope and spirit of the invention being indicated by the following claims.

TABLE 1
Isolation of CAF from Plant Materials (% Yield, dry weight basis)^{a}

| CAF Sources | % Yield |
|---|---|
| Corn bran | 20.05 |
| Corn stover | 40.20 |
| Rice fiber | 59.90 |
| Wheat bran | 14.30 |
| Wheat straw | 53.10 |
| Switchgrass | 32.70 |
| Miscanthus | 56.70 |
| Sugarcane bagasse | 52.00 |
| Sorghum bran (Black milled) | 25.84 |
| Sorghum bran (Sumac milled) | 38.50 |
| Sorghum bran (Burgundy milled) | 19.32 |
| Barley hulls | 26.85 |
| Barley straws | 49.75 |
| Carrot pomace | 14.80 |

^{a}Weight percent based on de-starched biomass

TABLE 2
Proximate Composition and Dietary Fiber Content of CAF Isolated from Plant Materials
(d.w.b.)

| | | | | | Crude | | | |
|---|---|---|---|---|---|---|---|---|
| CAF Sources | Ash | Protein | Starch | NDF | Fat | ISD | SDF | TDF |
| Corn bran | 1.54 | 0.56 ± 0.00 | 0.26 ± 0.01 | 92.58 ± 0.35 | 0.21 | 92.44 | 4.09 | 96.54 |
| Corn stover | 7.29 | 1.29 ± 0.00 | 0.16 ± 0.08 | 96.92 ± 0.10 | 0.10 | 95.30 | 0.89 | 96.20 |
| Rice fiber | 2.25 | 0.91 ± 0.05 | 0.21 ± 0.04 | 95.11 ± 0.72 | 0.04 | 98.63 | 0.00 | 98.63 |
| Wheat bran | 1.05 | 1.72 ± 0.08 | 0.36 ± 0.03 | 90.48 ± 0.41 | 0.00 | 92.03 | 0.00 | 92.03 |
| Wheat straw | 2.27 | 1.75 ± 0.00 | 0.05 ± 0.03 | 99.75 ± 0.21 | 0.36 | 97.55 | 0.00 | 97.55 |
| Switchgrass | 1.35 | 1.90 ± 0.04 | 0.09 ± 0.02 | 98.22 ± 0.31 | 0.48 | 99.45 | 0.00 | 99.45 |
| Miscanthus | 1.08 | 0.56 ± 0.05 | 0.16 ± 0.03 | 98.71 ± 0.15 | 0.14 | 99.61 | 0.00 | 99.61 |
| Sugarcane | 9.90 | 1.91 ± 0.00 | 0.06 0.04 | 98.55 ± 0.41 | 0.25 | 90.82 | 0.00 | 90.82 |
| bagasse | | | | | | | | |
| Sorghum bran | 1.76 | 16.49 ± 0.09 | 2.51 ± 0.05 | 87.06 ± 0.14 | 0.40 | 77.88 | 1.98 | 79.86 |
| (Black milled) | | | | | | | | |
| Sorghum bran | 1.07 | 23.82 ± 0.23 | 5.42 ± 0.24 | 70.04 ± 0.85 | 0.28 | 77.62 | 0.00 | 77.25 |
| (Sumac | | | | | | | | |
| milled) | | | | | | | | |
| Sorghum bran | 1.63 | 5.37 ± 0.06 | 0.91 ± 0.09 | 94.70 ± 0.18 | 0.28 | 91.80 | 9.44 | 101.89 |
| (Burgundy | | | | | | | | |
| milled) | | | | | | | | |
| Barley hulls | 1.00 | 0.89 ± 0.04 | 0.09 ± 0.08 | 96.54 ± 0.29 | 0.15 | 98.51 | 4.15 | 102.65 |
| Barley straws | 1.04 | 0.66 ± 0.03 | 0.11 ± 0.04 | 99.34 ± 0.39 | 0.44 | 97.57 | 6.84 | 104.41 |
| Carrot pomace | 1.79 | 2.20 ± 0.07 | 0.22 | 95.50 ± 0.59 | 0.70 | 94.7 ± 1.4 | 1.4 | 96.2 |

TABLE 3
Water Holding Capacity of CAF Isolated from Plant Materials

| | Water Held/ | Water Held/ |
|---|---|---|
| | Sample (g/g) | Sample (g/g) |
| | (Centrifugation, | (Centrifugation, |
| CAF Sources | 14K, 1 h) | 1K, 15 min.) |
| Corn bran (Drum Dried CAF) | 13.922 ± 0.434 | 32.767 ± 0.972 |
| Corn bran (Spray Dried CAF) | 15.397 ± 0.513 | 34.807 ± 0.378 |
| Corn stover | 7.159 ± 0.105 | 17.71 ± 1.33 |
| Rice fiber | 4.971 ± 0.099 | 6.374 ± 0.422 |
| Wheat bran | 6.782 ± 0.188 | 13.940 ± 0.479 |
| Wheat straw | 7.103 ± 0.452 | 23.748 ± 0.410 |
| Switchgrass | 6.768 ± 0.085 | 19.782 ± 0.714 |
| Miscanthus | 6.681 ± 0.188 | 16.847 ± 0.555 |
| Sugarcane bagasse | 7.082 ± 0.419 | 17.28 ± 0.73 |
| Sorghum bran (Black milled) | 5.538 ± 0.406 | 20.053 ± 0.746 |
| Sorghtan bran (Sumac milled) | 5.190 ± 0.201 | 20.127 ± 0.189 |
| Sorghum bran (Burgundy | 7.525 ± 0.580 | 32.807 ± 1.045 |
| milled) | | |
| Barley hulls | 6.167 ± 0.258 | 13.845 ± 0.259 |
| Barley straws | 7.622 ± 0.290 | 21.387 ± 0.590 |
| Carrot pomace | ND | 22.91 ± 1.94 |
| CAF prepared at Z Trim | | |
| Holdings, Inc. Plant | | |
| Corn bran (Drum dried CAF) | 9.257 ± 0.294 | 32.658 ± 0.619 |
| Corn bran (Spray dried CAF) | 10.763 ± 0.760 | 34.807 ± 0.378 |
| Rice fiber | 5.036 ± 0.158 | 7.950 ± 0.274 |

TABLE 4
ORAC Value of CAF Isolated from Plant Materials

| | ORAC Value |
|---|---|
| CAF Sources | (μmole Trolox/100 gram) |
| Corn bran (Drum Dried CAF) | 1560 |
| Corn bran (Spray Dried CAF) | 868 |
| Corn stover | 362 |
| Rice fiber | 414 |
| Wheat bran | 954 |
| Wheat straw | 493 |
| Switchgrass | 649 |
| Miscanthus | 392 |
| Sugarcane bagasse | 427 |
| Sorghum bran (Black milled) | 633 |
| Sorghum bran (Sumac milled) | 792 |
| Sorghum bran (Burgundy milled) | 938 |
| Barley hulls | 679 |
| Barley straws | 326 |
| Carrot pomace | 352 |
| CAF prepared at Z Trim Holdings, Inc. Plant | |
| Corn bran (Drum dried CAF) | 1560 |
| Corn bran (Spray dried CAF) | 868 |
| Rice fiber | 942 |

TABLE 5
Rheological properties of 4% suspensions of CAF Isolated from Plant
Materials: Apparent viscosity and Power Law parameters

| | Apparent | | |
|---|---|---|---|
| | viscosity at | Flow consistency | Flow |
| | shear rate of | index “K” | behavior index |
| | 1 s⁻¹ (cP) | (Pa · sⁿ) | (n) |
| Corn bran (Drum | 8500 | 10.45 | 0.50 |
| Dried CAF) | | | |
| Corn bran (Spray | 29100 | 36.45 | 0.25 |
| Dried CAF) | | | |
| Corn stover | 1900 | 2.72 | 0.36 |
| Rice fiber | 418 | 1.04 | 0.41 |
| Wheat bran | 639 | 0.78 | 0.41 |
| Wheat straw | 7770 | 11.11 | 0.26 |
| Miscanthus | 1760 | 2.43 | 0.36 |
| Sugarcane bagasse | 5730 | 6.97 | 0.27 |
| Sorghum bran (Black | 1030 | 1.49 | 0.46 |
| milled) | | | |
| Sorghum bran | 7250 | 9.35 | 0.45 |
| (Sumac milled) | | | |
| Sorghum bran | 4750 | 6.36 | 0.43 |
| (Burgundy milled) | | | |
| Barley hulls | 540 | 0.727 | 0.38 |
| Barley straws | 3450 | 4.93 | 0.32 |
| Carrot pomace | 8620 | 13.32 | 0.26 |
| Sugar-beet bagasse | 11700 | 18.31 | 0.32 |

TABLE 6
Carbohydrate Composition of CAF Isolated from Plant Materials

Sugar Content (Wt. %)

| | Glucose | Xylose | Arabinose | Total |
|---|---|---|---|---|
| Corn bran (Drum | 52.18 | 31.56 | 12.29 | 96.03 |
| Dried CAF) | | | | |
| Corn bran (Spray | 51.60 | 31.08 | 12.00 | 94.68 |
| Dried CAF) | | | | |
| Corn stover | 66.87 | 21.9 | 2.23 | 91.00 |
| Rice fiber | 64.67 | 20.47 | 2.04 | 87.18 |
| Wheat bran | 34.78 | 31.97 | 13.17 | 79.92 |
| Wheat straw | 60.72 | 23.30 | 2.69 | 86.71 |
| Switchgrass | 59.65 | 24.02 | 2.81 | 86.48 |
| Miscanthus | 60.74 | 21.39 | 2.33 | 84.46 |
| Sugarcane bagasse | 57.99 | 23.33 | 2.31 | 83.63 |
| Sorghum bran | 46.34 | 14.03 | 10.48 | 70.85 |
| (Black milled) | | | | |
| Sorghum bran | 54.79 | 11.69 | 7.87 | 74.35 |
| (Sumac milled) | | | | |
| Sorghum bran | 59.34 | 17.10 | 11.49 | 87.93 |
| (Burgundy milled) | | | | |
| Barley hulls | 52.89 | 31.66 | 5.74 | 90.29 |
| Barley straws | 66.70 | 21.74 | 2.52 | 90.96 |
| Carrot pomace | 73.87 | 14.46 | 2.38 | 90.71 |
| CAF prepared at | | | | |
| Z Trim Holdings, | | | | |
| Inc. Plant | | | | |
| Corn bran (Drum | 55.88 | 28.40 | 10.92 | 95.20 |
| dried CAF) | | | | |
| Corn bran (Spray | 62.14 | 24.92 | 9.77 | 96.83 |
| dried CAF) | | | | |
| Rice fiber | 70.63 | 20.05 | 1.70 | 92.38 |

TABLE 7(a)
Glycosyl-linkage composition of CAF isolated from corn bran

| | Relative peak |
|---|---|
| Glycosyl residue linkage | area (%) |
| t-Araf (terminally linked arabinofuronosyl residue) | 5.1 |
| t-Xylp (terminally linked xylopyranosyl residue) | 5.2 |
| 2-Araf (2-linked arabinofuranosyl residue) | 2.1 |
| t-Glc (terminally linked glucopyranosyl residue) | 6.1 |
| 3-Araf (3-linked arabinofuronosyl residue) | 2.0 |
| t-Gal (terminally linked galactopyranose residue) | 2.9 |
| 3-Xylp & 4-Arap or 5-Araf (3-linked xylopyranose | 0.8 |
| residue & 4-linked arabinopyranose residue or | |
| 5-linked arabinofuranose residue) | |
| 4-Xylp (4-linked xylopyranosyl residue) | 5.9 |
| 3-Glc (3-linked glucopyranosyl residue) | 0.7 |
| 3-Gal (3-inked galactopyranose residue) | 0.3 |
| 4-Man (4-linked mannopyranosyl residue) | 0.7 |
| 2-Gal (2-inked galactopyranose residue) | 0.0 |
| 6-Glc (6-linked glucopyranosyl residue) | 0.1 |
| 4-Glc (4-linked glucopyranosyl residue) | 55.5 |
| 3,4-Xylp (3,4-linked xylopyranosyl residue) | 7.7 |
| 3,4-Glc (3,4-linked glucopyranosyl residue) | 0.8 |
| 2,4-Glc (2,4-linked glucopyranosyl residue) | 0.4 |
| 4,6-Glc (4,6-linked glucopyranosyl residue) & | 3.8 |
| 2,3,4-Xylp (2,3,4-linked xylopyranosyl residue) | |
| Total | 100.0 |

TABLE 7(b)
Glycosyl-linkage composition of CAF isolated from rice fiber)

| | Relative peak |
|---|---|
| Glycosyl residue linkage | area (%) |
| Terminal Arabinofuranosyl residue (t-Araf) | 1.2 |
| Terminal Xylopyranosyl residue (t-Xyl) | 0.9 |
| 2 linked Arabinofuranosyl residue (2-Araf) | 0.2 |
| Terminal Glucopyranosyl residue (t-Glc) | 2.0 |
| 3 linked Arabinofuranosyl residue (3-Araf) | 0.1 |
| Terminal Galactopyranosyl residue (t-Gal) | 0.2 |
| 4 linked Arabinopyranosyl residue or 5 linked | 0.1 |
| Arabinofuranosyl residue (4-Arap or 5-Araf) | |
| 4 linked Xylopyranosyl residue (4-Xyl) | 23.7 |
| 4 linked Mannopyranosyl residue (4-Man) | 0.1 |
| 4 linked Glucopyranosyl residue (4-Glc) | 66.8 |
| 2,4 linked Xylopyranosyl residue (2,4-Xyl) | 0.5 |
| 3,4 linked Xylopyranosyl residue (3,4-Xyl) | 1.7 |
| 3,4 linked Glucopyranosyl residue (3,4-Glc) | 0.8 |
| 2,4 linked Glucopyranosyl residue (2,4-Glc) | 0.7 |
| 4,6 linked Glucopyranosyl residue (4,6-Glc) | 1.2 |
| Total | 100 |

TABLE 7(c)
Glycosyl-linkage composition of CAF isolated from wheat straw

| | Relative peak |
|---|---|
| Glycosyl residue linkage | area (%) |
| Terminal Arabinofuranosyl residue (t-Araf) | 2.4 |
| Terminal Xylopyranosyl residue (t-Xyl) | 1.1 |
| 2 linked Arabinofuranosyl residue (2-Araf) | 0.1 |
| Terminal Glucopyranosyl residue (t-Glc) | 1.5 |
| 3 linked Arabinofuranosyl residue (3-Araf) | 0.1 |
| Terminal Galactopyranosyl residue (t-Gal) | 0.2 |
| 4 linked Arabinopyranosyl residue or 5 linked | 0.2 |
| Arabinofuranosyl residue (4-Arap or 5-Araf) | |
| 4 linked Xylopyranosyl residue (4-Xyl) | 26.1 |
| 3 linked Glucopyranosyl residue (3-Glc) | 0.7 |
| 3 linked Galactopyranosyl residue (3-Gal) | 0.1 |
| 6 linked Glucopyranosyl residue (6-Glc) | 0.1 |
| 4 linked Glucopyranosyl residue (4-Glc) | 60.3 |
| 2,4 linked Xylopyranosyl residue (2,4-Xyl) | 0.8 |
| 3,4 linked Xylopyranosyl residue (3,4-Xyl) | 2.9 |
| 3,4 linked Glucopyranosyl residue (3,4-Glc) | 0.9 |
| 2,4 linked Glucopyranosyl residue (2,4-Glc) | 0.9 |
| 4,6 linked Glucopyranosyl residue (4,6-Glc) | 1.6 |
| Total | 100 |

TABLE 7(d)
Glycosyl-linkage composition of CAF isolated from miscanthus

| | Relative peak |
|---|---|
| Glycosyl residue linkage | area (%) |
| Terminal Arabinofuranosyl residue (t-Araf) | 1.8 |
| Terminal Xylopyranosyl residue (t-Xyl) | 0.8 |
| 2 linked Arabinofuranosyl residue (2-Araf) | 0.1 |
| Terminal Glucopyranosyl residue (t-Glc) | 1.8 |
| 3 linked Arabinofuranosyl residue (3-Araf) | 0.1 |
| Terminal Galactopyranosyl residue (t-Gal) | 0.1 |
| 4 linked Arabinopyranosyl residue or 5 linked | 0.2 |
| Arabinofuranosyl residue (4-Arap or 5-Araf) | |
| 4 linked Xylopyranosyl residue (4-Xyl) | 24.3 |
| 3 linked Glucopyranosyl residue (3-Glc) | 0.4 |
| 4 linked Mannopyranosyl residue (4-Man) | 0.2 |
| 4 linked Galactopyranosyl residue (4-Gal) | 0.1 |
| 4 linked Glucopyranosyl residue (4-Glc) | 65.2 |
| 2,4 linked Xylopyranosyl residue (2,4-Xyl) | 0.6 |
| 3,4 linked Xylopyranosyl residue (3,4-Xyl) | 2.3 |
| 3,4 linked Glucopyranosyl residue (3,4-Glc) | 0.6 |
| 2,4 linked Glucopyranosyl residue (2,4-Glc) | 0.5 |
| 4,6 linked Glucopyranosyl residue (4,6-Glc) | 1.1 |
| Total | 100 |

TABLE 7(e)
Glycosyl-linkage composition of CAF
isolated from sugarcane bagasse

| | Relative peak |
|---|---|
| Glycosyl residue linkage | area (%) |
| Terminal Arabinofuranosyl residue (t-Araf) | 1.7 |
| Terminal Xylopyranosyl residue (t-Xyl) | 0.8 |
| 2 linked Arabinofuranosyl residue (2-Araf) | 0.1 |
| Terminal Glucopyranosyl residue (t-Glc) | 0.8 |
| 3 linked Arabinofuranosyl residue (3-Araf) | 0.1 |
| Terminal Galactopyranosyl residue (t-Gal) | 0.1 |
| 4 linked Arabinopyranosyl residue or 5 linked | 0.2 |
| Arabinofuranosyl residue (4-Arap or 5-Araf) | |
| 4 linked Xylopyranosyl residue (4-Xyl) | 32.8 |
| 3 linked Glucopyranosyl residue (3-Glc) | 1.0 |
| 4 linked Mannopyranosyl residue (4-Man) | 0.2 |
| 6 linked Glucopyranosyl residue (6-Glc) | 0.1 |
| 4 linked Galactopyranosyl residue (4-Gal) | 0.1 |
| 4 linked Glucopyranosyl residue (4-Glc) | 53.3 |
| 2,4 linked Xylopyranosyl residue (2,4-Xyl) | 1.1 |
| 3,4 linked Xylopyranosyl residue (3,4-Xyl) | 3.3 |
| 3,4 linked Glucopyranosyl residue (3,4-Glc) | 1.0 |
| 2,4 linked Glucopyranosyl residue (2,4-Glc) | 1.1 |
| 4,6 linked Glucopyranosyl residue (4,6-Glc) | 2.1 |
| Total | 100 |

TABLE 7(f)
Glycosyl-linkage composition of CAF isolated from carrot pomace

| | Relative peak |
|---|---|
| Glycosyl residue linkage | area (%) |
| Terminal Arabinofuranosyl residue (t-Araf) | 1.4 |
| Terminal Fucopyranosyl residue (t-Fuc) | 0.2 |
| Terminal Arabinopyranosyl residue (t-Ara) | 0.1 |
| Terminal Xylopyranosyl residue (t-Xyl) | 0.7 |
| 2 linked Rhamnopyranosyl residue (2-Rha) | 0.2 |
| Terminal Mannopyranosyl residue (t-Man) | 0.9 |
| Terminal Glucopyranosyl residue (t-Glc) | 2.5 |
| 3 linked Arabinofuranosyl residue (3-Araf) | 0.1 |
| Terminal Galactopyranosyl residue (t-Gal) | 1.1 |
| 4 linked Arabinopyranosyl residue or 5 linked | 0.5 |
| Arabinofuranosyl residue (4-Arap or 5-Araf) | |
| 4 linked Xylopyranosyl residue (4-Xyl) | 5.1 |
| 2,4 linked Rhamnopyranosyl residue (2,4-Rha) | 0.5 |
| 2 linked Glucopyranosyl residue (2-Glc) | 0.1 |
| 4 linked Mannopyranosyl residue (4-Man) | 7.7 |
| 2 linked Galactopyranosyl residue (2-Gal) | 0.3 |
| 3,4 linked Arabinopyranosyl residue or 3,5 linked | 0.3 |
| Arabinofuranosyl residue (3,4-Arap or 3,5-Araf) | |
| 4 linked Galactopyranosyl residue (4-Gal) | 3.3 |
| 4 linked Glucopyranosyl residue (4-Glc) | 67.8 |
| 2,4 linked Xylopyranosyl residue (2,4-Xyl) | 0.4 |
| 3,4 linked Glucopyranosyl residue (3,4-Glc) | 1.3 |
| 2,4 linked Mannopyranosyl residue (2,4-Man) | 0.1 |
| 2,4 linked Glucopyranosyl residue (2,4-Glc) | 2.3 |
| 4,6 linked Mannopyranosyl residue (4,6-Man) | 0.2 |
| 4,6 linked Glucopyranosyl residue (4,6-Glc) | 2.9 |
| 2,3,4 linked Glucopyranosyl residue (2,3,4-Glc) | 0.2 |
| Total | 100 |

TABLE 8
Use of Corn and Oat CAF in Bakery Products for
Different Functionalities (Suggested Amount)

| | Corn CAF | Oat CAF | |
|---|---|---|---|
| Products | (Wt. %) | (Wt. %) | Functions |
| Biscuits | 0.25-0.75 | 1.0-1.5 | Moisture retention, slow |
| | | | staling and fat reduction |
| Buns and | 0.30-0.75 | 0.30-0.75 | Moisture retention and |
| Rolls | | | fat reduction |
| Muffins and | 0.50-1.0 | 1.0-2.0 | Trans and saturated fat |
| Sweet Breads | | | reduction) |
| Cakes and | 0.30-0.50 | 0.50-1.00 | Volume increase, |
| Bakery Mixes | | | structure improvement |
| | | | and fat reduction |
| Cookies and | 0.20-0.50 | 0.20-0.50 | Moisture retention and |
| Brownies | | | fat reduction |
| Pie Dough, | 0.50-1.0 | 0.75-1.5 | Breakage reduction, fat |
| Pizza Dough | | | reduction and improvement |
| and | | | in moisture migration |
| Pita Bread | | | |
| Pie Filling | 0.30-1.0 | Corn ZTrim | Syneresis reduction, fat |
| | | recommended | reduction and cost |
| | | | reduction |
| Tortillas | 0.20-0.50 | 0.50-1.0 | Fat reduction, structure |
| | | | improvement and cost |
| | | | reduction |
| Crackers and | 0.25-0.50 | 0.50-1.0 | Breakage and checking |
| Snack Foods | | | reduction |
| Enrobed | 0.25-1.0 | 0.50-1.0 | Moisture retention |
| Microwavable | | | |
| Dough | | | |
| Batter and | 0.50-2.0 | 0.50-2.5 | Fat uptake reduction and |
| Breading | | | crispiness improvement |
| Gluten Free | 0.30-0.50 | 0.50-1.0 | Volume increase and |
| Products | | | structure improvement |

Note:
Actual usage will vary depending upon applications.

TABLE 9
Use of Corn CAF in Bakery Products for Different
Functionalities (Suggested Amount)

| | Corn CAF | |
|---|---|---|
| Products | (Wt. %) | Functions |
| Cream Cheese | 0.50-2.0 | Improves yield and reduces |
| | | fat and cost |
| Ricotta Cheese | 0.50-1.0 | Improves yield and reduces |
| | | fat and cost |
| Processed Cheese | 0.25-1.0 | Improves yield and reduces |
| and Cheese Sauces | | fat and cost |
| Sour Cream and | 0.50-3.0 | Improves yield and reduces |
| Dip | | fat and cost. Also thickener |
| | | and viscosity builder |
| Ice Cream, Ice | 1.25-1.25 | Improves mouth feel, |
| Milk and Frozen | | controls ice crystal |
| Novelties | | formation and thaw |
| | | stabilization |
| Pudding and | 0.50-3.0 | Improves yield and reduces |
| Custards | | fat and cost. Also |
| | | thickener and viscosity |
| | | builder |
| Whipped Toppings | 0.30-0.75 | Stabilizes foam and reduces |
| | | cost |
| Yogurt, Yogurt | 0.10-0.50 | Stabilizer, thickener/ |
| Drinks and | | viscosity builder and |
| Smoothies | | control syneresis |

Note:
Actual usage will vary depending upon application.

TABLE 10
Use of Corn CAF in Meat Products for Different
Functionalities (Suggested Amount)

| | Corn CAF | |
|---|---|---|
| Products | (%) | Functions |
| Ground Beef Patty | 0.25-1.0 | Reduces cost and improves |
| | | yield and texture |
| Ground Turkey and | 0.50-1.0 | Reduces cost and improves |
| Chicken Patty | | yield and texture |
| Sausage and Hot | 0.50-1.0 | Binder and reduces cost |
| Dogs | | and improves yield |
| Meat Fillings | 0.25-075 | Emulsification and |
| | | syneresis control |
| Coating and | 0.50-2.0 | Improves adhesion and |
| Breading for | | reduces fat in fried food |
| Meats | | |

Note:
Actual usage will vary depending upon application.

TABLE 11
Use of Corn CAF in Dressing, Sauces, Mayo and Dips
for Different Functionalities (Suggested Amount)

| | Corn CAF | |
|---|---|---|
| Products | (Wt. %) | Functions |
| Mayo Spread | 0.50-3.0 | Reduces cost and fat |
| Spoonable Salad | 0.50-3.0 | Reduces cost and fat |
| Dressings | | |
| Pourable Salad | 0.50-2.0 | Reduces cost and fat |
| Dressings | | |
| Dips | 0.50-3.0 | Reduces cost and fat |
| Sauces | 0.50-2.0 | Reduces cost and fat |
| Salsa | 0.25-0.50 | Reduces cost and controls |
| | | syneresis |
| Barbecue and | 0.25-1.0 | Thickener, viscosity |
| Tomato Sauces | | builder and control |
| | | syneresis |

Note:
Actual usage will vary depending upon application.

TABLE 12
Formulations of stable free flowing (A) fat
powder (B) gravy, and (C) soup using corn CAF

| | |
|---|---|
| (Wt. g) | Wt. % |

(A) Fat Powder

| Corn BFG | 47.00 | 47.00 |
|---|---|---|
| Coconut Oil | 26.00 | 26.00 |
| Shortening | 24.00 | 24.00 |
| Salt | 0.50 | 0.50 |
| Trisodium Phosphate | 0.50 | 0.50 |
| Disodium Phosphate | 1.00 | 1.00 |
| Corn CAF | 1.00 | 1.00 |
| Total | 100 | 100 |
| Note: The free flowing fat powder can be incorporated in | | |
| formulation of stable dry mixes of gravy, chicken cream soup, | | |
| and many other products of similar attributes. CAF is used to | | |
| stabilize the fat in powder form and for ease of use. | | |
| (B) Dry Gravy Mix | | |
| Corn CAF | 5.40 | 22.50 |
| Chicken Bouillion | 6.00 | 25.00 |
| Black Pepper 34 mesh | 0.20 | 0.83 |
| Corn BFG and fat blend | 12.40 | 51.67 |
| | 24 | 100 |

Add 1 part gravy mix to 9 parts of hot water

(C) Chicken Cream Soup Dry Mix

| | | |
|---|---|---|
| Nonfat dry powdered milk | 50.00 | 54.82 |
| Dried onion flakes | 4.00 | 4.39 |
| Chicken Bouillion | 10.00 | 10.96 |
| Dried basil | 0.20 | 0.22 |
| Dried thyme | 0.40 | 0.44 |
| Black pepper 34 mesh | 0.50 | 0.55 |
| Corn CAF | 8.10 | 8.88 |
| Corn BFG and fat blend | 18.00 | 19.74 |
| | 91.20 | 100 |

Add 1 part soup mix to 6 parts of hot water

TABLE 13
Formulations of bars and nutritional drinks with corn
CAF in combination with corn BFG for fiber fortification
up to more than 5% or 2.75 gram per serving.

| | | |
|---|---|---|
| Item | Quantity (g) | Percentage |

(A) CAF Nutritional Bar with 5 grams of Fiber/Serving,
3:1 Corn BFG:CAF

| | | |
|---|---|---|
| Apple Juice Concentrate | 28.18 | 15.76 |
| Corn CAF | 3.50 | 1.96 |
| Corn BFG | 10.50 | 5.87 |
| Salt | 1.25 | 0.70 |
| Chocolate Baking Chips Semi-Sweet | 30.00 | 16.78 |
| Texturized Protein (Toasted) | 6.56 | 3.67 |
| TVP | 6.56 | 3.67 |
| Soybean Oil | 12.50 | 6.99 |
| Flax Seed | 6.00 | 3.36 |
| Vanilla Extract | 1.25 | 0.70 |
| Brown Sugar | 15.00 | 8.39 |
| Honey | 19.38 | 10.84 |
| Molasses | 1.88 | 1.05 |
| Soy Protein Isolate | 13.75 | 7.69 |
| Rolled Oats | 5.00 | 2.80 |
| Puffed Rice | 17.50 | 9.79 |
| Totals | 178.81 | 100.00 |
| Procedures: | | |
| 1. Hydrate CAF with the Apple | | |
| Juice Concentrate. | | |
| 2. Mix all other liquids in with CAF | | |
| Gel/Slurry. | | |
| 3. Add all remaining powders. | | |
| 4. Incorporate all other pieces until | | |
| All coated with liquid mixture. | | |
| 5. Form into bars and bake at 250 F. | | |
| Until dried approx: 20 minutes | | |

NOTES:
% Moisture 14.0% approx. CAF is used to modify viscosity, manage
moisture, lower water activity to extend shelf-life, allow for pliability
during extrusion to minimize breakage, remove glycerin and to replace
caloric viscosity modifiers.
(B) CAF Nutritional Drink with 12 grams Fiber/Serving,
10:1 Corn BFG:CAF

| | | |
|---|---|---|
| Water | 396.00 | 76.36 |
| Corn CAF | 2.00 | 0.39 |
| Corn BFG | 20.50 | 3.95 |
| Sugar | 35.00 | 6.75 |
| Non Fat Dry Milk | 25.00 | 4.82 |
| Cocoa Powder | 10.00 | 1.93 |
| Dark Chocolate Flavor - Flavor Chem. | 1.33 | 0.26 |
| Vanilla- Tahiti - Neilson Massey | 0.65 | 0.13 |
| Soybean Oil | 10.00 | 1.93 |
| HFCS - Chicago | | |
| Sweeteners | 15.00 | 2.89 |
| Xanthan Gum | 1.00 | 0.19 |
| Soy Protein Isolate | 2.00 | 0.39 |
| Chocolate Flavor -Flavor Chem. | 0.15 | 0.03 |
| Totals | 518.63 | 100.00 |
| Procedures: | | |
| 1. Mix Water and CAF together | | |
| To form a gel slurry. | | |
| 2. Add the NFDM. Continue to mix. | | |
| 3. Add the Sugar, HFCS, Cocoa Powder, | | |
| Soy Protein Isolate, continue to mix. | | |
| 4. Add Soybean Oil, corn BFG, and | | |
| Xanthan Gum. Add Flavors. | | |
| 5. Add Flavors. | | |
| 6. Run Mix through shear to | | |
| assure Smooth silky texture. | | |

NOTES:
Viscosity: Spindle #3 @ 12 rpm's = 1650-1700 cps:
CAF is used to modify the viscosity, keep solids suspended and minimize
settling, help functionalize flavors by well distributing them throughout
the system, remove or reduce imported viscosity modifiers, remove calorie
contributing viscosity modifiers, will not breakdown under ultra high
shear and temperature.

TABLE 14
Formulations of food emulsions such as Alfredo sauce,
Macroni and Cheese sauce, and shelf-stable ranch
dressing with corn CAF and corn BFG blends
(A) Cheese sauce for Macaroni and Cheese

| Ingredients | Quantity (g) | Percentage |
|---|---|---|
| Water | 238.88 | 60.01 |
| Soybean Oil | 5.66 | 1.42 |
| Whey Powder - Sweet | 21.72 | 5.46 |
| Mac and Cheese Blend | 8.80 | 2.21 |
| NFDM | 12.92 | 3.25 |
| Supernatural Cheese blend | 10.96 | 2.75 |
| *Sartori - intensa cheddar | 82.32 | 20.68 |
| Corn BFG | 10.72 | 2.69 |
| Corn CAF | 3.04 | 0.76 |
| Butterbuds - Aged cheddar | 1.19 | 0.30 |
| Butterbuds - Buttermilk | 0.66 | 0.17 |
| Butterbuds - High | 0.97 | 0.24 |
| Concentration | | |
| Xanthan Gum | 0.20 | 0.05 |
| Total | 398.04 | 100.00 |

NOTES:
1. Combine water, corn CAF and com BFG. Shear for 3 min using an
emulsion blender.
2. Add soybean oil to xanthan gum, mix well and add to mixture. Shear
for another minute.
3. Add all dry ingredients and supernatural cheese blend then shear.
4. Heat in double boiler to 190° F.
5. Remove from heat and add Sartori cheese and mix until melted.
*used Sartori - Intensa Cheese Product because no other American
Cheese was Provided.
6. Add to Elbo Macaroni and toss.
CAF allows for excellent microwaveability by well distributing and
managing water, reduce saturated fat, reduce calories, allows for
emulsification stability, and also allows for excellent freeze/thaw.
(B) Corn CAF Alfredo sauce

| Ingredient | Quantity (g) | Percentage |
|---|---|---|
| Water | 290.36 | 51.49 |
| Milk (skim) | 129.00 | 22.87 |
| Nonfat Dry Milk | 10.00 | 1.77 |
| Corn CAF | 6.90 | 1.22 |
| Cream Powder | 3.00 | 0.53 |
| Corn BFG | 3.50 | 0.62 |
| Soybean Oil | 48.21 | 8.55 |
| Swiss Cheese | 54.34 | 9.64 |
| Butterbuds, high | 5.47 | 0.97 |
| concentrate | | |
| Cheesebuds, Parmesan | 3.10 | 0.55 |
| Cheesebuds, Emmenthal | 2.49 | 0.44 |
| Salt | 5.20 | 0.92 |
| Koji Aji | 1.10 | 0.20 |
| Garlic Powder | 0.40 | 0.07 |
| Black pepper (34 msh) | 0.39 | 0.07 |
| Black pepper (20 msh) | 6.25 | 0.04 |
| White pepper | 0.10 | 0.02 |
| Nutmeg | 0.15 | 0.03 |
| | 563.96 | 100.00 |

NOTES:
1. Combine water and corn CAF. Shear for 3 min using an emulsion
blender.
2. Add soybean oil to xanthan gum, mix well and add to mixture. Shear
for another minute.
3. Add all dry ingredients and shear.
4. Add Swiss cheese to mixture and heat in a sauce pan until cheese
is melted. About 150° F.
5. Remove from heat.
6. Shear with emulsion blender for about 2 minutes.
CAF eliminates syneresis, eliminates emulsion breakage and oil
separation, reduce saturated fats, allows for excellent freeze/
thaw, contributes to calorie reduction

(C) Shelf Stable Ranch Dressing

| Ingredients | Percentage | Quantity (g) |
|---|---|---|
| Water | 66.2732 | 730.5360 |
| Extra heavy duty mayo | 19.5045 | 215.0000 |
| Vinegar, 120 GR. | 3.0010 | 33.0800 |
| HFCS | 2.9937 | 33.0000 |
| Corn CAF | 2.0003 | 22.0500 |
| Salt | 1.8020 | 19.8640 |
| Egg Yolks | 0.9979 | 11.0000 |
| MSG | 0.6006 | 6.6200 |
| Buttermilk Powder | 0.4999 | 5.5100 |
| Granulated Garlic | 0.4999 | 5.5100 |
| Corn BFG | 0.3003 | 3.3100 |
| Autolyzed Yeast | 0.3003 | 3.3100 |
| Lactic Acid | 0.3003 | 3.3100 |
| Lemon Concentrate | 0.2005 | 2.2100 |
| Granulated Onion | 0.1197 | 1.3200 |
| Potassium Sorbate | 0.0998 | 1.1000 |
| Sodium Benzoate | 0.0998 | 1.1000 |
| Starter Distillate | 0.0998 | 1.1000 |
| Citric Acid | 0.0998 | 1.1000 |
| Lemon Flavor, Weber | 0.0798 | 0.8800 |
| Black pepper 34 mesh | 0.0499 | 0.5500 |
| Dill weed, whole | 0.0336 | 0.3700 |
| Parsley granules | 0.0336 | 0.3700 |
| Nisin preservative | 0.0100 | 0.1100 |
| | 100.0000 | 1102.3100 |

Ph: avg. 3.81
Salt: avg. 2.42
% TA avg. 0.85
Allows for emulsion stability under ambient storage, contributes to
lowering calories by lowering the fat content, keeps solids well
distributed and suspended.

TABLE 15
Formulation of chocolate pudding and
pita chips with corn CAF and corn BFG
(A) Z Trim Chocolate Pudding

| Item | Quantity (Grams) | Percentage |
|---|---|---|
| Evaporated Milk 2% | 389.14 | 37.585 |
| Corn CAF | 25.77 | 2.489 |
| Skim Milk | 357.86 | 34.564 |
| Sugar | 175.27 | 16.928 |
| NFDM | 20.94 | 2.022 |
| Semi Sweet Chocolate pieces | 57.75 | 5.578 |
| Vanilla extract | 4.73 | 0.457 |
| Corn BFG | 2.00 | 0.193 |
| Salt | 1.00 | 0.097 |
| Guar Gum | 0.50 | 0.048 |
| Flavor Chem. Dark Chocolate | 0.40 | 0.039 |
| Flavor | | |
| | 1035.36 | 100.000 |
| Procedures: | | |
| 1. Mix the corn CAF and corn | | |
| BFG with the evaporated milk | | |
| until smooth | | |
| 2. Add NFDM, Skim Milk, | | |
| Salt, and sugar. | | |
| 3. Add Guar Gum, Mix with | | |
| high Speed mixer (food | | |
| processor). | | |
| 4. Heat to 150° F. slowly; | | |
| adding the Chocolate with | | |
| continuous stirring. | | |
| 5. And remaining flavors. | | |

NOTES:
CAF is used as a viscosity modifier, saturated fat reducer, calorie
reducer by replacing starch, to control syneresis, is a process stable
ingredient as it will not break down under ultra high shear and
temperature.

(B) Pita Chips

| Ingredients | Quantity (g) | Percentage |
|---|---|---|
| Yeast | 7.09 | 0.50 |
| Water, Warm | 226.80 | 15.96 |
| Sugar | 4.40 | 0.31 |
| Bread Flour | 569.00 | 40.05 |
| Whole Wheat Flour | 300.00 | 21.12 |
| Corn CAF | 8.50 | 9.60 |
| Corn BFG | 24.00 | 1.69 |
| Salt | 6.50 | 0.46 |
| Sugar | 4.00 | 0.28 |
| Water | 215.00 | 15.13 |
| Olive Oil | 55.32 | 3.89 |
| | 1420.61 | 100.00 |
| After Bake Baste: | | |
| Olive Oil | 227.00 | |
| Black Pepper | 2.00 | |
| Garlic | 4.00 | |
| Basil | 0.50 | |

NOTES:
Bake: Disk 450° F. 3 Minutes/Side
Dry Baking 250° F. 50 Minutes
CAF is used to improve structure, reduce breakage and to manage product
moisture through processing.

TABLE 16
The product formulation by mixing corn CAF and corn BFG as shown
in above tables defines functional blends of the two that can
seamlessly displace other hydrocolloids and provide for clean
label. The compositions are summarized below as they constitute
technical basis for production and sale of commercial blends

| Consumer Product | Corn BFG and corn | Percent Ratio |
|---|---|---|
| Example | CAF Ratio (g/g) | of Blends |
| Nutrition Bar | 5.87/1.97 | 74.68/24.94 |
| Pita Chip | 73.80/26.20 | 73.80/26.20 |
| Nutrition Drink | 3.95/0.39 | 91.01/8.99 |
| Cheese Sauce | 2.69/0.76 | 77.97/22.03 |
| Alfredo Sauce | 0.62/1.22 | 37.70/66.30 |
| Ranch Dressing | 0.3003/2.003 | 13.03/86.97 |
| Chocolate Pudding | 0.193/2.489 | 7.20/92.80 |

We claim:

1. A process for the preparation of cellulosic arabinoxylan fiber comprising:
(a) mixing ground agricultural materials in water at temperatures in the range of about 75° C. to about 100° C. to form a suspension, adjusting the pH of said suspension from about 5.2 to about 6.8, and adding thermostable α-amylase to said suspension,
(b) adjusting the pH of said suspension to about 11.5,
(c) subjecting said suspension to shearing at about 10,000 rpm for about 1 hour and centrifuging said suspension at about 14,000×g for about 10 minutes to form a supernatant and a solid residue,
(d) mixing said solid residue with water at temperatures in the range of about 75° C. to about 100° C. to forma suspension,
(e) subjecting said suspension from (d) to shearing at about 10,000 rpm for about 5 minutes, cooling said suspension to about room temperature and centrifuging said suspension at about 14,000×g for about 10 minutes to form a supernatant and a solid residue,
(f) mixing said solid residue from (e) with water at temperatures in the range of about 75° C. to about 100° C. to form a suspension,
(g) subjecting said suspension from (f) to shearing at about 10,000 rpm for about 5 minutes, cooling said suspension to about room temperature and centrifuging said suspension at about 14,000×g for about 10 minutes to form a supernatant and a solid residue,
(h) mixing said solid residue from (g) with water at temperatures in the range of about 75° C. to about 100° C. and stirring for about 5 minutes to form a suspension,
(i) subjecting said suspension from (h) to a first shearing at about 20,000 rpm for about 5 minutes and subjecting said suspension to a second shearing at about 20,000 rpm for about 1 minute, cooling said suspension to about room temperature and centrifuging said suspension at about 14,000×g for about 10 minutes to form a supernatant and a solid residue,
(j) mixing said solid residue from (i) with water at temperatures in the range of about 75° C. to about 100° C. and stirring for about 5 minutes to form a suspension and subjecting said suspension to a first shearing at about 20,000 rpm for about 5 minutes and subjecting said suspension to a second shearing at about 20,000 rpm for about 1 minute, cooling said suspension to about room temperature and centrifuging said suspension at about 14,000×g for about 10 minutes to form a supernatant and a solid residue, and
(k) repeating step (j) until a clear supernatant is obtained and drying the final solid residue containing cellulosic arabinoxylan fiber to form dried cellulosic arabinoxylan fiber.

2. The process according to claim 1, comprising:
(a) mixing ground agricultural materials in water at about 85° C. to form a suspension, adjusting the pH of said suspension from about 5.2 to about 6.8, and adding thermostable α-amylase to said suspension and stirring about 1 hour,
(b) adjusting the pH of said suspension to about 11.5 and stirring said suspension for about 30 minutes,
(c) subjecting said suspension to shearing at about 10,000 rpm for about 1 hour and centrifuging said suspension at about 14,000×g for about 10 minutes to form a supernatant and a solid residue,
(d) mixing said solid residue with water at temperatures in the range of about 75° C. to about 100° C. and stirring for about 5 minutes to form a suspension,
(e) subjecting said suspension from (d) to shearing at about 10,000 rpm for about 5 minutes, cooling said suspension to about room temperature and centrifuging said suspension at about 14,000×g for about 10 minutes to form a supernatant and a solid residue,
(f) mixing said solid residue from (e) with water at temperatures in the range of about 75° C. to about 100° C. and stirring for about 5 minutes to form a suspension,
(g) subjecting said suspension from (f) to shearing at about 10,000 rpm for about 5 minutes, cooling said suspension to about room temperature and centrifuging said suspension at about 14,000×g for about 10 minutes to form a supernatant and a solid residue,
(h) mixing said solid residue from (g) with water at temperatures in the range of about 75° C. to about 100° C. and stirring for about 5 minutes to form a suspension,
(i) subjecting said suspension from (h) to a first shearing at about 20,000 rpm for about 5 minutes and subjecting said suspension to a second shearing at about 20,000 rpm for about 1 minute, cooling said suspension to about room temperature and centrifuging said suspension at about 14,000×g for about 10 minutes to form a supernatant and a solid residue,
(j) mixing said solid residue from (i) with water at temperatures in the range of about 75° C. to about 100° C. and stirring for about 5 minutes to form a suspension and subjecting said suspension to a first shearing at about 20,000 rpm for about 5 minutes and subjecting said suspension to a second shearing at about 20,000 rpm for about 1 minute, cooling said suspension to about room temperature and centrifuging said suspension at about 14,000×g for about 10 minutes to form a supernatant and a solid residue, and
(k) repeating step (j) until a clear supernatant is obtained and drying the final solid residue containing cellulosic arabinoxylan fiber to form dried cellulosic arabinoxylan fiber.

3. The method according to claim 1, wherein said drying in (k) is spray drying or drum drying.

4. Cellulosic arabinoxylan fiber prepared by the process according to claim 1.

5. An edible formulation, comprising the cellulosic arabinoxylan fiber prepared by claim 1, wherein said cellulosic arabinoxylan fiber functions as bulking agents in the edible formulation.

6. A method of stabilizing an emulsion, comprising mixing an effective stabilizing amount of the cellulosic arabinoxylan fiber produced by the process according to claim 1 with an emulsion to stabilize said emulsion.

7. A method of increasing the water holding capacity of a composition, comprising mixing an effective water holding increasing amount of the cellulosic arabinoxylan fiber produced by the process according to claim 1 with a composition to increase the water holding capacity of said composition.

8. A method of increasing the bulk of a composition, comprising mixing an effective bulk increasing amount of the cellulosic arabinoxylan fiber produced by the process according to claim 1 with a composition to increase the water holding capacity of said composition.

9. A method of increasing the viscosity of a composition, comprising mixing an effective viscosity increasing amount of the cellulosic arabinoxylan fiber produced by the process according to claim 1 with a composition to increase the viscosity of said composition.
